(19) United States
(12) Patent Application Publication
(10) Pub. No.: US 2026/0029669 A1
(43) Pub. Date: Jan. 29, 2026

(54) SEMICONDUCTOR PHOTONICS DEVICES AND METHODS OF FORMATION

(71) Applicant: Taiwan Semiconductor Manufacturing Company, Ltd., Hsinchu (TW)

(72) Inventors: Shu-Wei CHANG, Taipei City (TW); Chia-Hua CHU, Zhubei City (TW); Sheng Kai YEH, Taichung City (TW); Feng YUAN, Hsinchu City (TW); Chih-Tsung SHIH, Hsinchu City (TW); Chi-Yuan SHIH, Hsinchu (TW); Shih-Fen HUANG, Jhubei (TW)

(21) Appl. No.: 18/784,391

(22) Filed: Jul. 25, 2024

(51) Int. Cl. G02F 1/025; G02F 1/21

(52) U.S. Cl. CPC G02F 1/025; G02F 1/212

(57) ABSTRACT

A semiconductor photonics device includes an optical modulator structure that is thermally coupled to a heater structure for heating a waveguide structure of the optical modulator structure to modulate input optical signals by thermo-optic modulation. The heater structure includes a semiconductor heater element that is electrically coupled to a first electrode (e.g., a Vx electrode) by one or more first contacts, and is electrically coupled to a second electrode (e.g., a ground electrode) by a plurality second contacts. The one or more first contacts and the plurality of second contacts enable an electrical input to be applied across a plurality of parallel contact points to the semiconductor heater element, thereby enabling lower phase shift voltage to be used for achieving sufficient power for heating the waveguide structure of the optical modulator structure.

### BACKGROUND

A semiconductor device may be configured to use optical signals for high speed and secure data transmission between integrated circuits and/or semiconductor dies of the semiconductor device. An optical signal may be transferred through a waveguide in the semiconductor device. The waveguide enables confinement of the optical signal, which may reduce optical loss and increase propagation efficiency for the optical signal. Data may be encoded into an optical signal by modulating light into optical pulses through an optical modulator. The optical pulses are then transferred to the waveguide for propagation to other regions of the semiconductor device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1E are diagrams of an example semiconductor photonics device described herein.

FIGS. 2A and 2B are diagrams of an example implementation of heating a waveguide of an optical modulator structure described herein.

FIGS. 3A-3O are diagrams of an example implementation of forming a semiconductor photonics device (or a portion thereof) described herein.

FIGS. 4A-4C are diagrams of an example semiconductor photonics device described herein.

FIGS. 5A and 5B are diagrams of an example semiconductor photonics device described herein.

FIGS. 6A and 6B are diagrams of an example semiconductor photonics device described herein.

FIG. 7 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A photonic integrated circuit of a semiconductor photonics device may include an optical modulator structure. Some optical modulator structures modulate input optical signals through electro-optical modulation. An electrical input (e.g., an electrical current, a voltage) is applied to terminals of an optical modulator structure, and the electrical input generates an electric field in the optical modulator structure. The electric field modifies the resonant frequency of the optical modulator structure, thereby causing the phase of the input optical signals to be modulated.

Another type of optical modulator structure includes a thermo-optic modulator that modulates the phase of input optical signals through thermo-optic effect. A thermal phase shifter (TPS) structure (or thermo-optic phase shifter heater) is thermally coupled with the waveguide of the optical modulator structure. An electrical input is applied to the terminals of the TPS structure, and the electrical resistance of the TPS structure dissipates the electrical input in the form of heat generation. The heat is provided to the waveguide, which modifies the temperature (and therefore, the refractive index) of the waveguide, thereby enabling the phase of the input optical signals to be modified.

The TPS structure of a thermo-optic modulator may include one or more types of materials. In some cases, a TPS structure includes one or more metal materials. Metal materials generally have low electrical resistivity and can enable a sufficient amount of power to be generated for the TPS structure with a relatively low phase shift voltage (Vx). In other cases, a TPS structure includes one or more semiconductor materials such as silicon (Si). Semiconductor materials typically have higher thermal conductivity than metal materials, which enables the TPS structure to achieve high temperatures more efficiently than TPS structures formed of metal. However, semiconductor materials also have higher resistivity and use much higher phase shift voltages to achieve sufficient power generation compared to TPS structures formed of metal. The higher phase shift voltages may increase the power consumption of the TPS structure, which lowers the operating efficiency of the TPS structure.

In some implementations described herein, a semiconductor photonics device includes an optical modulator structure that is thermally coupled to a heater structure (e.g., a TPS structure or thermo-optic phase shifter heater) for heating a waveguide structure of the optical modulator structure to modulate input optical signals by thermo-optic modulation. The heater structure includes a semiconductor heater element that is electrically coupled to a first electrode (e.g., a V_{π} electrode) by one or more first contacts, and is electrically coupled to a second electrode (e.g., a ground electrode) by a plurality second contacts. The one or more first contacts and the plurality of second contacts enable an electrical input to be applied across a plurality of parallel contact points to the semiconductor heater element, thereby enabling lower phase shift voltage to be used for achieving sufficient power for heating the waveguide structure of the optical modulator structure. In particular, the one or more first contacts and the plurality of second contacts effectively partition the semiconductor heater element into a plurality of segments, and each segment is coupled to pair of contacts that includes one the one or more first contacts and one of the plurality of second contacts. The pair of contacts is configured to locally power the segment as opposed to the entire area of the semiconductor heater element, resulting in lower resistance and enabling a lower phase shift voltage to be used.

Thus, partitioning the semiconductor heater element into a plurality of segments using the one or more first contacts and the plurality of second contacts enables the heater structure to operate more efficiently and at lower voltages. Moreover, since the heater structure can operate at lower voltage, the heater structure is compatible with other complementary metal-oxide-semiconductor (CMOS) integrated circuit devices of the semiconductor photonics device, and can be formed using the similar CMOS manufacturing processes as the CMOS integrated circuit devices.

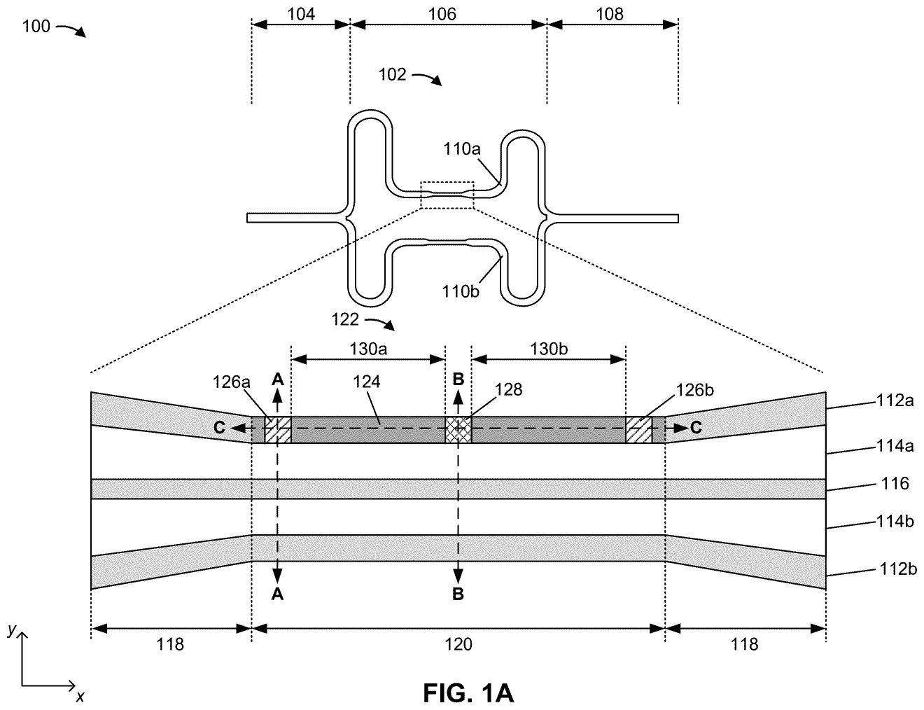

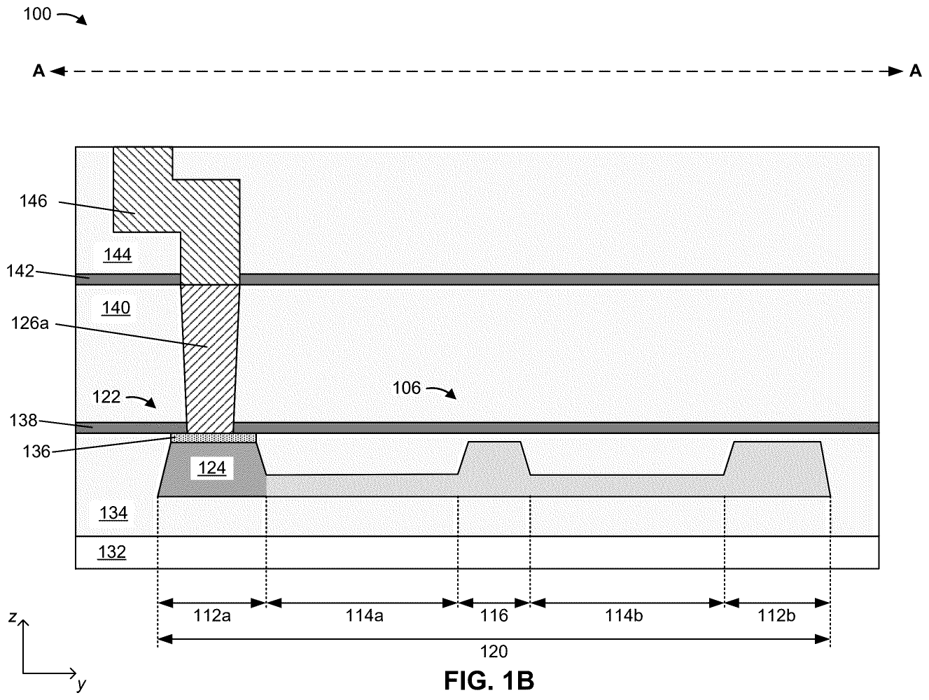

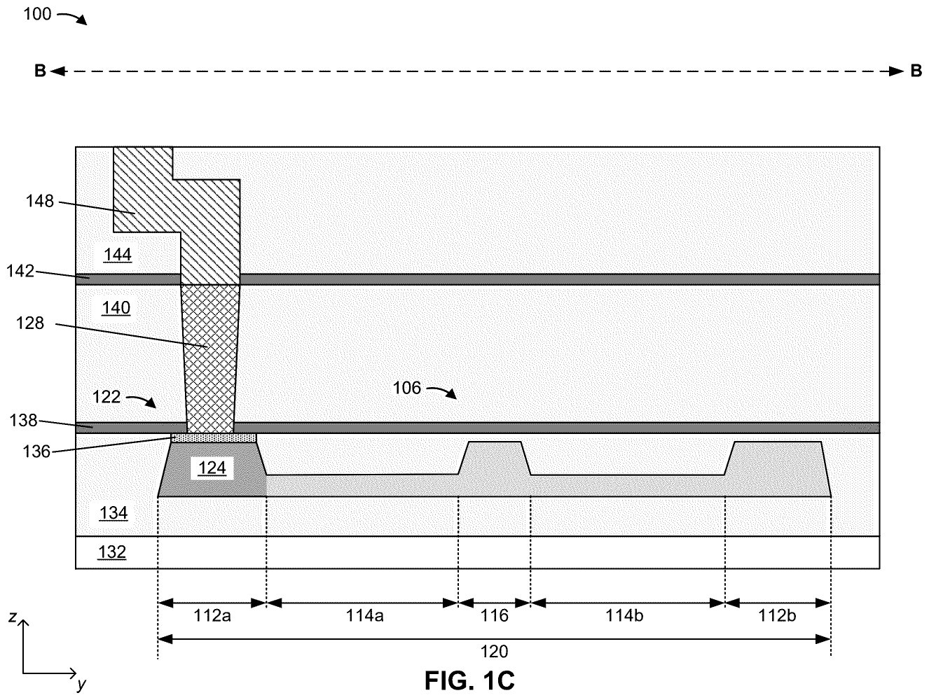

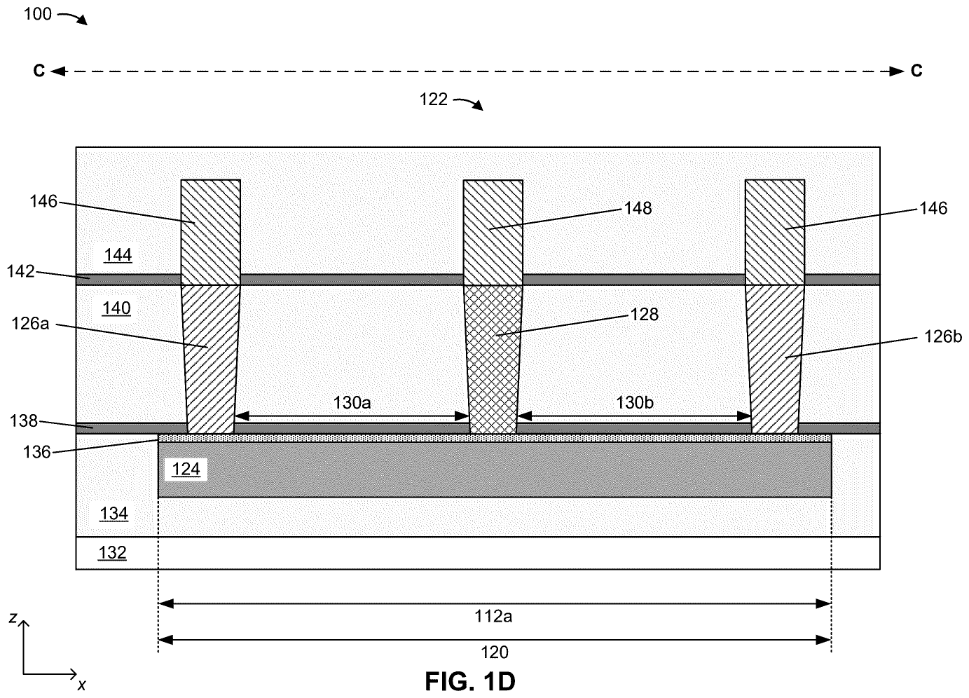

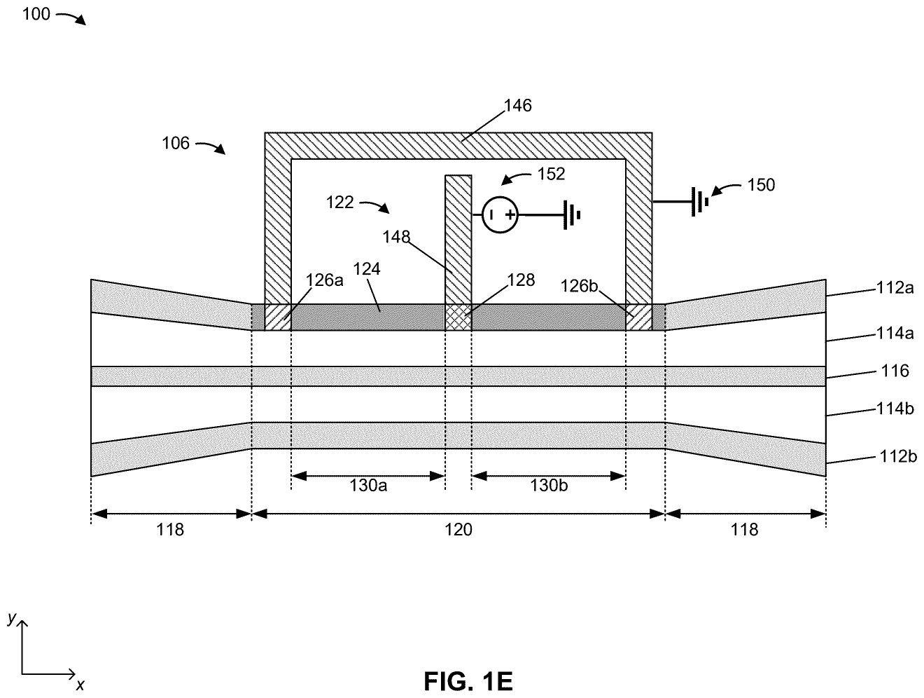

FIGS. 1A-1E are diagrams of an example semiconductor photonics device 100 described herein. FIG. 1A illustrates a top view of the semiconductor photonics device 100. As shown in FIG. 1A, the semiconductor photonics device 100 includes a photonic integrated circuit 102 configured for optical communication within the semiconductor photonics device 100 and/or between the semiconductor photonics device 100 and another device external to the semiconductor photonics device 100. The photonic integrated circuit 102 includes a waveguide structure 104 optically and/or physically coupled with an optical modulator structure 106. The photonic integrated circuit 102 may also include another waveguide structure 108, where the waveguide structure 104 and the waveguide structure 108 are coupled with the optical modulator structure 106 at opposing ends of the optical modulator structure 106.

The photonic integrated circuit 102 may include a Mach-Zender modulator (MZM) structure or another type of optical modulator integrated circuit in which optical signals (e.g., input optical signals, modulated optical signals) are coupled between one or more waveguides (e.g., the waveguide structure 104 and/or the waveguide structure 108) and the optical modulator structure 106. The waveguide structure 104 may correspond to an input waveguide for providing optical signals to the optical modulator structure 106, and the waveguide structure 108 may correspond to an output waveguide for receiving modulated optical signals from the optical modulator structure 106. Thus, optical signals may propagate through the photonic integrated circuit 102 primarily in an x-direction indicated in FIG. 1A.

The waveguide structures 104 and 108 may each include approximately straight-lined structures of silicon (Si), germanium (Ge), and/or another waveguide material through which optical signals may propagate. The waveguide structures 104 and 108 may each extend in the x-direction. Alternatively, waveguide structures 104 and/or 108 may be curved or may have another top view shape or profile.

The optical modulator structure 106 may include a silicon (Si) or another type of semiconductor material, and may include a plurality of optical modulator segments 110a and 110b spaced apart from each other in a y-direction indicated in FIG. 1A. Ends of the optical modulator segments 110a and 110b are coupled with the waveguide structure 104, and optical signals received from the waveguide structure 104 are split between the optical modulator segments 110a and 110b. This enables the optical signals propagating through the optical modulator segments 110a and 110b to be modulated differently (e.g., modulated at different frequencies, modulated at different phases), or enables the optical signals propagating through one of the optical modulator segments 110a or 110b to be modulated while the optical signals propagating through the other of the optical modulator segments 110a or 110b are unmodulated.

FIG. 1A further illustrates a detailed view of a portion of the optical modulator segment 110a. The optical modulator segment 110b may have a similar configuration, or may have a different configuration, than that illustrated in the detailed view for the portion of the optical modulator segment 110a.

As shown in the detailed view in FIG. 1A, the optical modulator structure 106 includes a plurality of pad sections 112a and 112b that are respectively coupled to respective connection sections 114a and 114b. Moreover, the pad sections 112a and 112b are coupled to a waveguide structure 116 of the optical modulator structure 106 through the connection sections 114a and 114b, respectively. The pad sections 112a and 112b are located laterally adjacent to opposing sides of the waveguide structure 116 in the y-direction. The pad sections 112a and 112b, the connection sections 114a and 114b, and the waveguide structure 116 are arranged in the y-direction and extend in the x-direction. Moreover, the pad sections 112a and 112b, the connection sections 114a and 114b, and the waveguide structure 116 may all be formed from the same semiconductor layer of the semiconductor photonics device 100 such that the pad sections 112a and 112b, the connection sections 114a and 114b, and the waveguide structure 116 are all physically coupled through the same semiconductor layer. The semiconductor layer (and thus, the pad sections 112a and 112b, the connection sections 114a and 114b, and the waveguide structure 116) may include silicon (Si), silicon doped with one or more types of dopants (e.g., n-type dopants, p-type dopants), silicon germanium (SiGe), germanium (Ge), and/or another semiconductor material.

As further shown in the detailed view in FIG. 1A, the optical modulator segment 110a includes transition segments 118 in which a lateral (y-direction) width of the connection sections 114a and 114b decreases between main segments of the optical modulator segment 110a and a modulation segment 120 of the optical modulator segment 110a. A heater structure 122 is included in the modulation segment 120. The heater structure 122 is configured to generate heat that is injected into the waveguide structure 116 through the connection section 114a to modify the temperature of the waveguide structure 116 in the modulation segment 120. Thus, the heater structure 122 may be referred to as a modulator heater structure. The change in temperature of the waveguide structure 116 in the modulation segment 120 modifies the refractive index of the waveguide structure 116, which enables optical signals propagating through the waveguide structure 116 to be modulated by thermo-optic modulation. Thus, the heater structure 122 may be referred to as a TPS structure or a thermo-optic phase shifter heater.

As shown in the detailed view in FIG. 1A, the heater structure 122 includes a semiconductor heater region 124, which includes a doped semiconductor region in the pad section 112a of the optical modulator structure 106. Thus, the heater structure 122 may be referred to as a semiconductor heater structure. The semiconductor heater region 124 of the heater structure 122 extends alongside the waveguide structure 116 in the modulation segment 120 and is thermally coupled to the waveguide structure 116 through the connection section 114a. Heat generated in the semiconductor heater region 124 may propagate to the waveguide structure 116 through the connection section 114a.

The semiconductor heater region 124 includes a semiconductor material (e.g., silicon (Si), silicon germanium (SiGe), germanium (Ge)) that is doped with one or more types of dopants. For example, the semiconductor heater region 124 may include silicon doped with one or more n-type dopants such as phosphorous (P) and/or arsenic (As), among other examples. As another example, the semiconductor heater region 124 may include silicon doped with one or more p-type dopants such as boron (B) and/or gallium (Ga), among other examples.

As further shown in the detailed view in FIG. 1A, the heater structure 122 includes a plurality of contact structures that are electrically coupled to the semiconductor heater region 124. The plurality of contact structures include a plurality of contact structures 126a and 126b, and a contact structure 128. The contact structures 126a and 126b are located at opposing ends of the semiconductor heater region 124, and the contact structure 128 is located between the contact structures 126a and 126b. The contact structures 126a, 126b, and 128 are located on the semiconductor heater region 124 and are arranged in the x-direction along the semiconductor heater region 124.

The contact structures 126a and 126b may be electrically coupled in parallel to an electrical ground in the semiconductor photonics device 100, and the contact structure 128 may be electrically coupled to a voltage source in the semiconductor photonics device 100. This enables a phase shift voltage input to be split across segments 130a and 130b (e.g., semiconductor heater segments) of the semiconductor heater region 124 in parallel. For example, a phase shift voltage may be applied across the contact structure 126a and the contact structure 128 to apply the phase shift voltage to the segment 130a, and the phase shift voltage may be applied across the contact structure 126b and the contact structure 128 to apply the phase shift voltage to the segment 130b. This enables a lower phase shift voltage to be used for achieving sufficient power for generating heat in the segments 130a and 130b as opposed to applying a larger phase shift voltage across the entire length of the semiconductor heater region 124.

The shorter length of each segment 130a and 130b, relative to the overall length of the entire semiconductor heater region 124, results in each segment 130a and 130b having a lower electrical resistance than the electrical resistance across the entire length of the entire semiconductor heater region 124. This is because the resistance of each segment 130a and 130b is based in part on the length of each segment 130a and 130b, and the resistance of the overall semiconductor heater region 124 is based in part on the overall length of the semiconductor heater region 124. For the same cross-sectional area, partitioning the semiconductor heater region 124 into segments 130a and 130b of approximately equal length results in each of the segments 130a and 130b having a resistance of:

$${R}_{S} = \frac{{R}_{H}}{{n}^{2}}$$

where R_{S} corresponds to the resistance of a segment (e.g., the segment 130a, the segment 130b) of the semiconductor heater region 124, R_{H} corresponds to the resistance of the overall semiconductor heater region 124, and n corresponds to the quantity of segments. Thus, for two segments of approximately equal length, each segment has a resistance that is approximately ¼^{th} the resistance of the overall semiconductor heater region 124. Increasing the quantity of segments exponentially decreases the resistance of each segment.

For the same power level that is used for generating heat in the semiconductor heater region 124, the reduction in resistance for each segment of the semiconductor heater region 124 enables the phase shift voltage applied to each segment to be reduced inversely proportional to the quantity of segments:

$${V}_{π S} = \frac{{V}_{π H}}{n}$$

Thus, for two segments of approximately equal length, a segment phase shift voltage V_{πS} that can be applied to each segment to achieve a particular power level is approximately one half the phase shift voltage V_{πH} that would be needed to achieve the same power level if applied across the entire length of the semiconductor heater region 124. Accordingly, arranging the contact structures 126a, 126b, and 128 along the semiconductor heater region 124 such that lower segment phase shift voltage V_{πS} can be applied to each of the segments 130a and 130b instead of applying a larger phase shift voltage V_{πH} across the entire length of the semiconductor heater region 124 enables the semiconductor heater region 124 to generate the same amount of heat more efficiently at lower voltages.

While the examples above are described in the context of the segments 130a and 130b having approximately equal length, the semiconductor heater region 124 may be partitioned by the contact structures 126a, 126b, and 128 such that the segments 130a and 130b (and/or additional segments) have different lengths in the x-direction. In some implementations, an x-direction length of a segment (e.g., a segment 130a, a segment 130b) may be included in a range of approximately 5 microns to approximately 25 microns. If the x-direction length of a segment of the semiconductor heater region 124 is less than approximately 5 microns, the density of contact structures above the semiconductor heater region 124 may increase to the point where the parasitic resistance of the contact structures increases power consumption and decreases thermal efficiency. If the x-direction length of a segment of the semiconductor heater region 124 is greater than approximately 25 microns, the segment phase shift voltage V_{πS} that can be applied to each segment to achieve a particular power level may result in increased power consumption by the heater structure 122, reducing the operating efficiency of the heater structure 122. If the x-direction length of a segment of the semiconductor heater region 124 is included in a range of approximately 5 microns to approximately 25 microns, a low parasitic resistance may be achieved for the contact structures and a low power level may achieved for the heater structure 122. However, other values and ranges other than approximately 5 microns to approximately 25 microns are within the scope of the present disclosure.

FIG. 1B illustrates a cross-section view of the semiconductor photonics device 100 along the line A-A in FIG. 1A. Thus, the cross-section view illustrated in FIG. 1B is in the y-direction across a modulation segment 120 of the optical modulator structure 106 of the semiconductor photonics device 100. In particular, the cross-section view illustrated in FIG. 1B is across a portion of the modulation segment 120 that includes the contact structure 126a.

As shown in FIG. 1B, the optical modulator structure 106 and the semiconductor heater region 124 of the associated heater structure 122 may be formed and/or included in a semiconductor layer that is located above a semiconductor substrate 132 of the semiconductor photonics device 100. The semiconductor substrate 132 may include a layer of silicon (Si) material, germanium (Ge) material, and/or another semiconductor material. The semiconductor substrate 132 may include the same semiconductor material as the semiconductor layer in which the optical modulator structure 106 and the semiconductor heater region 124 are formed, or may include a different semiconductor material.

As further shown in FIG. 1B, the semiconductor heater region 124 is included in a portion of the pad section 112a of the optical modulator structure 106. The semiconductor heater region 124 (and thus, the pad section 112a) is located laterally adjacent to the waveguide structure 116 of the optical modulator structure 106, and is physically and thermally coupled to the waveguide structure 116 by the connection section 114a. The pad section 112b is physically and thermally coupled to the waveguide structure 116 by the connection section 114b.

The optical modulator structure 106 and the semiconductor heater region 124 may be encapsulated in a dielectric layer 134. The dielectric layer 134 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material. A portion of the dielectric layer 134 under the optical modulator structure 106 and the semiconductor heater region 124 may correspond to a buried oxide (BOX) layer of a silicon on insulator (SOI) substrate in which the semiconductor photonics device 100 is formed. Another portion of the dielectric layer 134 laterally surrounding the optical modulator structure 106 and the semiconductor heater region 124, and above the optical modulator structure 106 and the semiconductor heater region 124, may correspond to a shallow trench isolation (STI) portion of the dielectric layer 134.

A silicide layer 136 may be included on the semiconductor heater region 124 of the heater structure 122. The silicide layer 136 may include a metal silicide layer such as a titanium silicide (TiSi), ruthenium silicide (RuSi), cobalt silicide (CoSi), and/or another type of metal silicide material. The silicide layer 136 may be included to achieve a sufficiently low contact resistance between the semiconductor heater region 124 and the contact structures 126a, 126b, and 128 of the heater structure 122.

Additional dielectric layers are included above the optical modulator structure 106, above the semiconductor heater region 124 of the heater structure, and above the dielectric layer 134. The additional dielectric layers may include an etch stop layer (ESL) 138 above the dielectric layer 134, an interlayer dielectric (ILD) layer 140 above the ESL 138, another ESL 142 above the ILD layer 140, and/or another ILD layer 144 above the ESL 142, among other examples. In some implementations, ILD layers and ESLs may be arranged in an alternating manner in the z-direction in the semiconductor photonics device 100.

The ESL 138, the ILD layer 140, the ESL 142, and the ILD layer 144 may each include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), an undoped silica glass (USG), a carbon doped silicon oxide, and/or another dielectric material. In some implementations, the ESLs 138 and 142 include a first dielectric material (or a first dielectric material composition), and the ILD layers 140 and 144 include a second dielectric material (or a second dielectric material composition) that is different from the first dielectric material. This enables the ESLs 138 and 142, and the ILD layers 140 and 144, to be etched using different types of etchants.

As further shown in FIG. 1B, the contact structure 126a of the heater structure 122 extends through the ESL 138 and the ILD layer 140 in the z-direction. The contact structure 126a may land on the silicide layer 136 such that the contact structure 126a is on and electrically coupled to the semiconductor heater region 124 of the heater structure 122 through the silicide layer 136. The contact structure 126a may include a via, a contact plug, a conductive pillar, and/or another type of conductive structure. The contact structure 126a may include tungsten (W), cobalt (Co), ruthenium (Ru), titanium (Ti), aluminum (Al), copper (Cu) or gold (Au), among other examples of conductive materials. In some implementations, one or more liners (e.g., barrier liners, adhesion liners) are included between the contact structure 126a and the surrounding dielectric layers. The one or more liners may include silicon oxide (SiOₓ), silicon nitride (SiₓN_{y}), silicon oxide nitride (SiON), tantalum (Ta), tantalum nitride (TaN), titanium nitride (TiN), and/or another suitable liner material.

As further shown in FIG. 1B, the contact structure 126a is electrically coupled and/or physically coupled to a metallization layer 146 above the contact structure 126a. The metallization layer 146 may be included in the ESL 142 and in the ILD layer 144 above the contact structure 126a. The metallization layer 146 may correspond to an electrode (e.g., a ground electrode) of the heater structure 122, and the metallization layer 146 may electrically couple the contact structure 126a to an electrical ground.

The metallization layer 146 may include one or more conductive structures, including one or more vias, one or more trenches, one or more contact plugs, one or more conductive traces, and/or other types of conductive structures. The metallization layer 146 may include one or more electrically conductive metals, such as tungsten (W), cobalt (Co), ruthenium (Ru), titanium (Ti), aluminum (Al), copper (Cu) or gold (Au), among other examples. In some implementations, one or more liners (e.g., barrier liners, adhesion liners) are included between the metallization layer 146 and the surrounding dielectric layers. The one or more liners may include silicon oxide (SiOₓ), silicon nitride (SiₓN_{y}), silicon oxide nitride (SiON), tantalum (Ta), tantalum nitride (TaN), titanium nitride (TiN), and/or another suitable liner material.

FIG. 1C illustrates another cross-section view of the semiconductor photonics device 100 along the line B-B in FIG. 1A. Thus, the cross-section view illustrated in FIG. 1C is in the y-direction across a modulation segment 120 of the optical modulator structure 106 of the semiconductor photonics device 100. In particular, the cross-section view illustrated in FIG. 1C is across a portion of the modulation segment 120 that includes the contact structure 128.

As shown in FIG. 1C, the contact structure 128 of the heater structure 122 extends through the ESL 138 and the ILD layer 140 in the z-direction. The contact structure 128 may land on the silicide layer 136 such that the contact structure 128 is on and electrically coupled to the semiconductor heater region 124 of the heater structure 122 through the silicide layer 136. The contact structure 128 may include a via, a contact plug, a conductive pillar, and/or another type of conductive structure. The contact structure 128 may include tungsten (W), cobalt (Co), ruthenium (Ru), titanium (Ti), aluminum (Al), copper (Cu) or gold (Au), among other examples of conductive materials. In some implementations, the contact structure 126a and the contact structure 128 include the same material (or the same material composition). In some implementations, the contact structure 126a and the contact structure 128 include different materials (or different material composition). In some implementations, one or more liners (e.g., barrier liners, adhesion liners) are included between the contact structure 128 and the surrounding dielectric layers. The one or more liners may include silicon oxide (SiOₓ), silicon nitride (SiₓN_{y}), silicon oxide nitride (SiON), tantalum (Ta), tantalum nitride (TaN), titanium nitride (TiN), and/or another suitable liner material.

As further shown in FIG. 1C, the contact structure 128 is electrically coupled and/or physically coupled to a metallization layer 148 above the contact structure 128. The metallization layer 148 may be included in the ESL 142 and in the ILD layer 144 above the contact structure 128. The metallization layer 148 may correspond to an electrode (e.g., a V_{π} electrode) of the heater structure 122, and the metallization layer 148 may electrically couple the contact structure 128 to a voltage source (e.g., a phase shift voltage source) of the semiconductor photonics device 100.

The metallization layer 148 may include one or more conductive structures, including one or more vias, one or more trenches, one or more contact plugs, one or more conductive traces, and/or other types of conductive structures. The metallization layer 148 may include one or more electrically conductive metals, such as tungsten (W), cobalt (Co), ruthenium (Ru), titanium (Ti), aluminum (Al), copper (Cu) or gold (Au), among other examples. In some implementations, one or more liners (e.g., barrier liners, adhesion liners) are included between the metallization layer 148 and the surrounding dielectric layers. The one or more liners may include silicon oxide (SiOₓ), silicon nitride (SiₓN_{y}), silicon oxide nitride (SiON), tantalum (Ta), tantalum nitride (TaN), titanium nitride (TiN), and/or another suitable liner material.

FIG. 1D illustrates another cross-section view of the semiconductor photonics device 100 along the line C-C in FIG. 1A. Thus, the cross-section view illustrated in FIG. 1D is in the x-direction along the semiconductor heater region 124 of the heater structure 122 in the modulation segment 120 of the optical modulator structure 106.

As shown in FIG. 1D, the contact structures 126a, 126b, and 128 of the heater structure 122 are included on the semiconductor heater region 124, and are arranged in the x-direction along the semiconductor heater region 124. The contact structure 126a is located at a first end of the semiconductor heater region 124 of the heater structure 122, the contact structure 126b is located at a second end of the semiconductor heater region 124 of the heater structure 122 opposing the first end, and the contact structure 128 is located between the contact structures 126a and 126b in the x-direction. The segment 130a of the semiconductor heater region 124 is located between the contact structures 126a and 128, and the segment 130b of the semiconductor heater region 124 is located between the contact structures 126b and 128. The metallization layer 146 is located above and electrically coupled to the contact structures 126a and 126b, and the metallization layer 148 is located above and electrically coupled to the contact structure 128.

The contact structure 126b may land on the silicide layer 136 such that the contact structure 126b is on and electrically coupled to the semiconductor heater region 124 of the heater structure 122 through the silicide layer 136. The contact structure 126b may include a via, a contact plug, a conductive pillar, and/or another type of conductive structure. The contact structure 126b may include tungsten (W), cobalt (Co), ruthenium (Ru), titanium (Ti), aluminum (Al), copper (Cu) or gold (Au), among other examples of conductive materials. In some implementations, the contact structure 126a and the contact structure 126b include the same material (or the same material composition). In some implementations, the contact structure 126a and the contact structure 126b include different materials (or different material composition). In some implementations, one or more liners (e.g., barrier liners, adhesion liners) are included between the contact structure 126b and the surrounding dielectric layers. The one or more liners may include silicon oxide (SiOₓ), silicon nitride (SiₓN_{y}), silicon oxide nitride (SiON), tantalum (Ta), tantalum nitride (TaN), titanium nitride (TiN), and/or another suitable liner material.

FIG. 1E illustrates a top view of a portion of the optical modulator structure 106 that includes the heater structure 122. FIG. 1E illustrates additional details of the metallization layers 146 and 148. As shown in FIG. 1E, the metallization layer 146 is electrically coupled and/or physically coupled to the contact structures 126a and 126b such that the contact structures 126a and 126b are electrically coupled in parallel, and such that the contact structures 126a and 126b are electrically coupled in parallel to an electrical ground 150.

The metallization layer 148 is electrically coupled and/or physically coupled to the contact structure 128 such that the contact structure 128 is electrically coupled to a voltage source 152. The parallel connections of the contact structures 126a and 126b to the electrical ground 150, and the connection of the contact structure 128 to the voltage source 152, enables a phase shift voltage to be applied to the segment 130a across the contact structure 126a and 128, and enables the phase shift voltage to be applied to the segment 130b across the contact structure 126b and 128, in parallel.

As indicated above, FIGS. 1A-1E are provided as an example. Other examples may differ from what is described with regard to FIGS. 1A-1E.

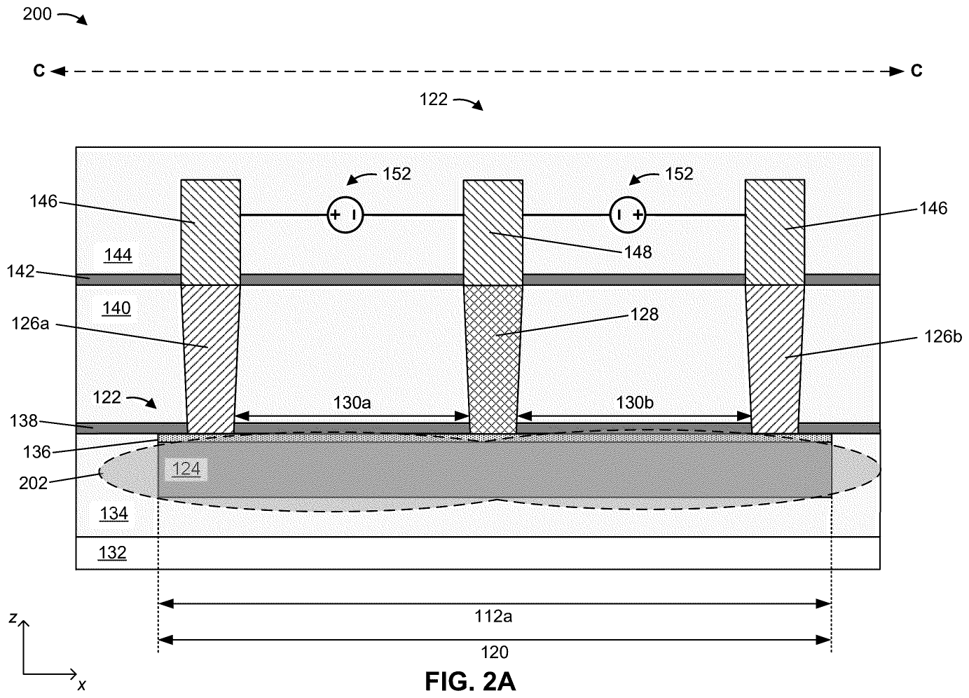

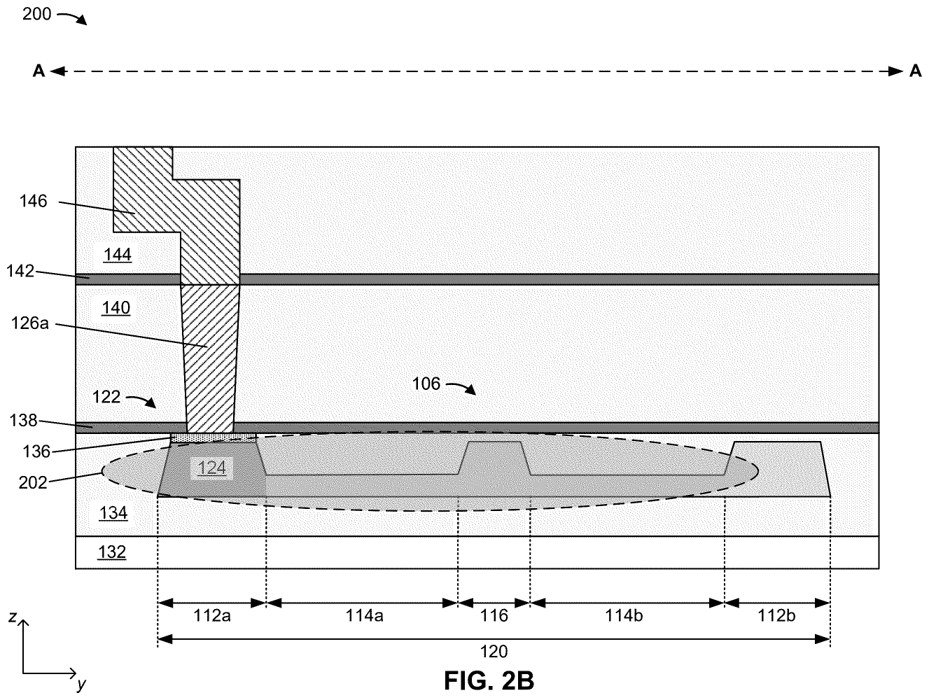

FIGS. 2A and 2B are diagrams of an example implementation 200 of heating a waveguide structure 116 of an optical modulator structure 106 described herein. As shown in FIGS. 2A and 2B, the heater structure 122 associated with the optical modulator structure 106 may be operated by applying a phase shift voltage to the semiconductor heater region 124. In particular, an referring to FIG. 2A, the phase shift voltage may be applied across the segment 130a by applying the phase shift voltage across the contact structures 126a and 128, and the phase shift voltage may be applied across the segment 130b by applying the phase shift voltage across the contact structures 126b and 128.

The phase shift voltage across the contact structures 126a and 128 causes an electrical current to flow through the segment 130a of the semiconductor heater region 124, which causes joule heating to occur in the semiconductor heater region 124. Specifically, the electrical resistance of the material of the segment 130a dissipates a portion of the electrical current, which results in the electrical energy of the electrical current being converted to thermal energy. Similarly, the phase shift voltage across the contact structures 126b and 128 causes an electrical current to flow through the segment 130b of the semiconductor heater region 124, which causes joule heating to occur in the semiconductor heater region 124. In this way, a heating region 202 is generated in the semiconductor heater region 124.

As shown in FIG. 2B, the heating region 202 extends through the connection section 114a and into the waveguide structure 116 of the optical modulator structure 106. In this way, the heat generated by the heater structure 122 in the heating region 202 is provided through the connection section 114a and into the waveguide structure 116, which enables the waveguide structure 116 to be heated.

As indicated above, FIGS. 2A and 2B are provided as an example. Other examples may differ from what is described with regard to FIGS. 2A and 2B.

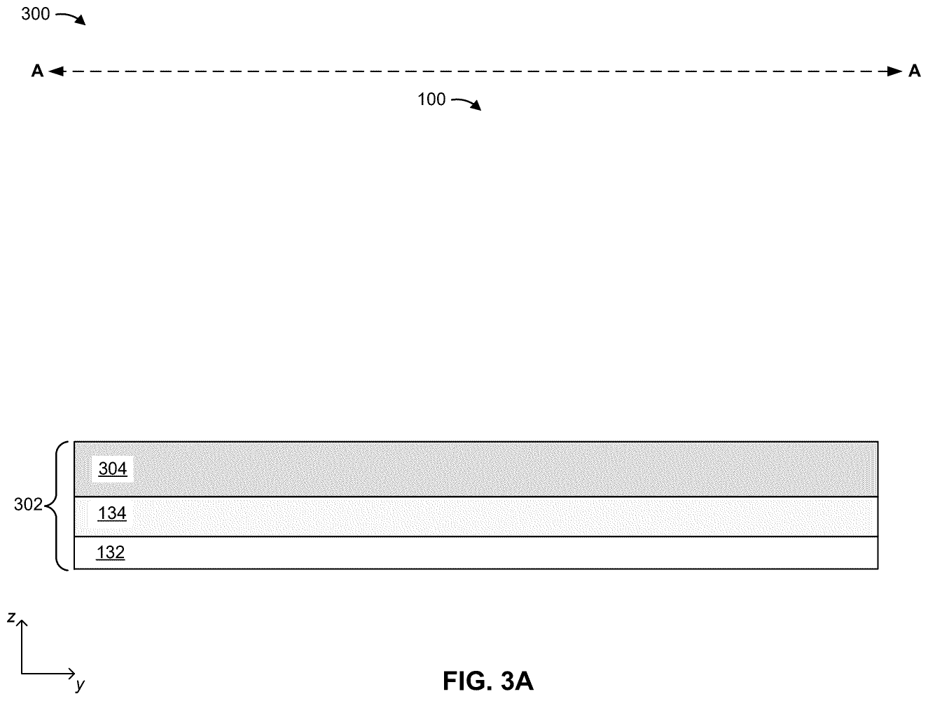

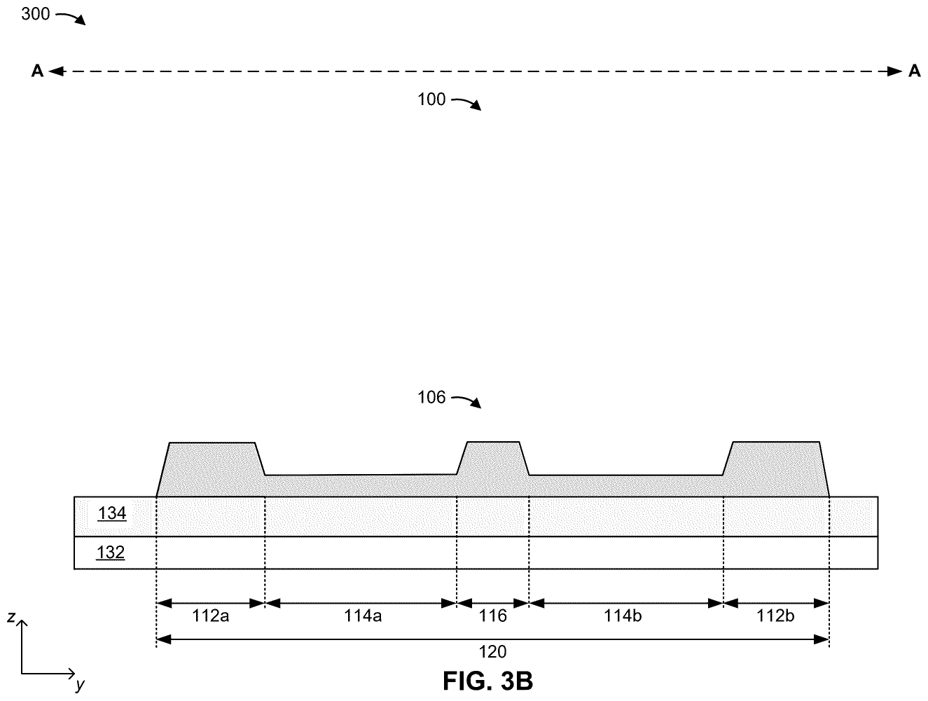

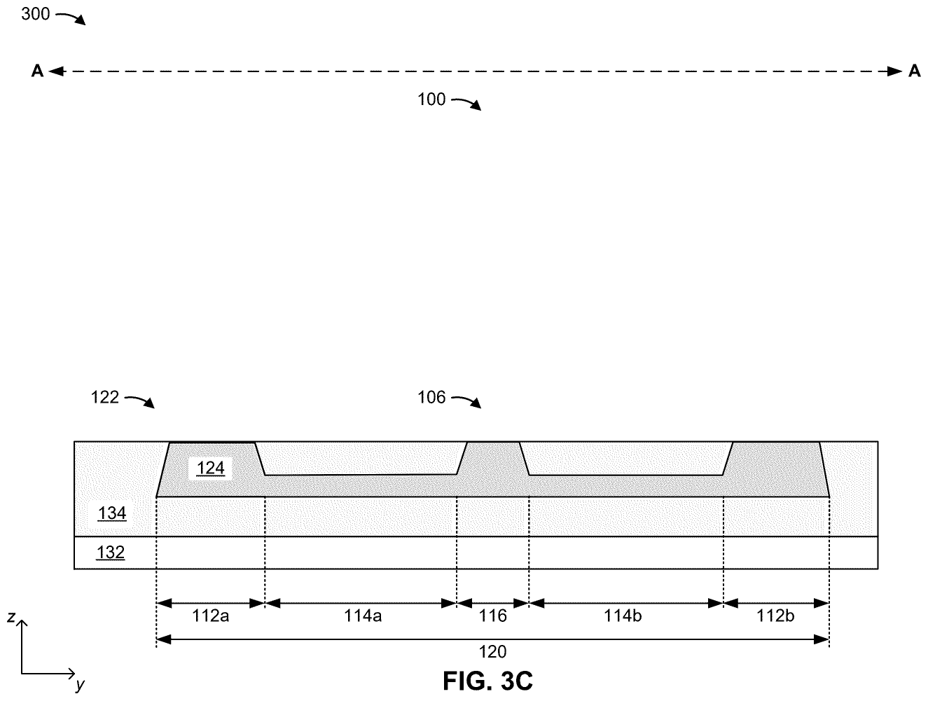

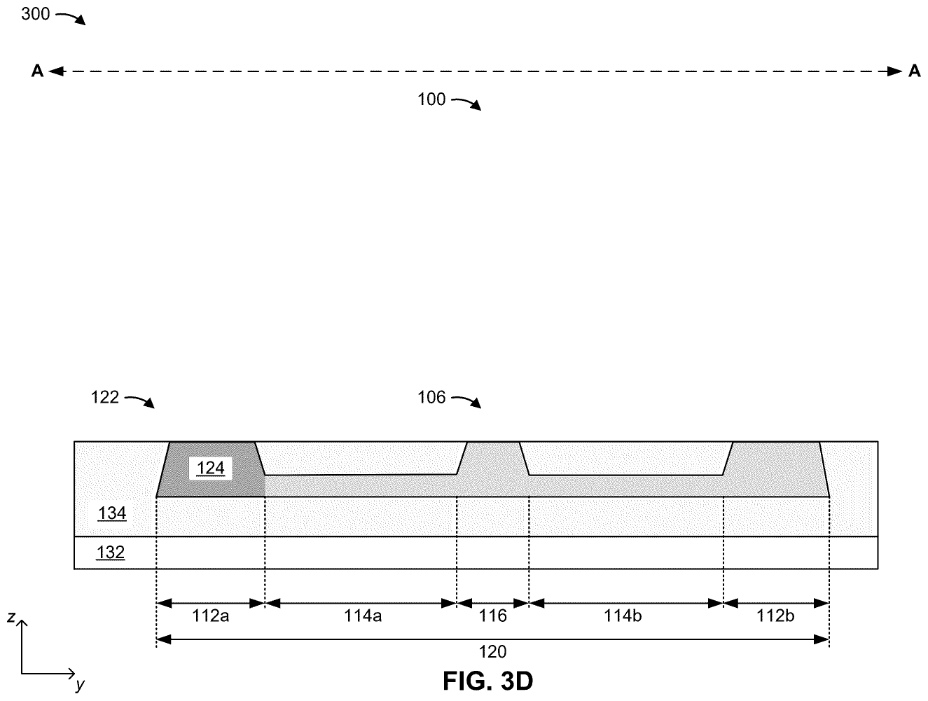

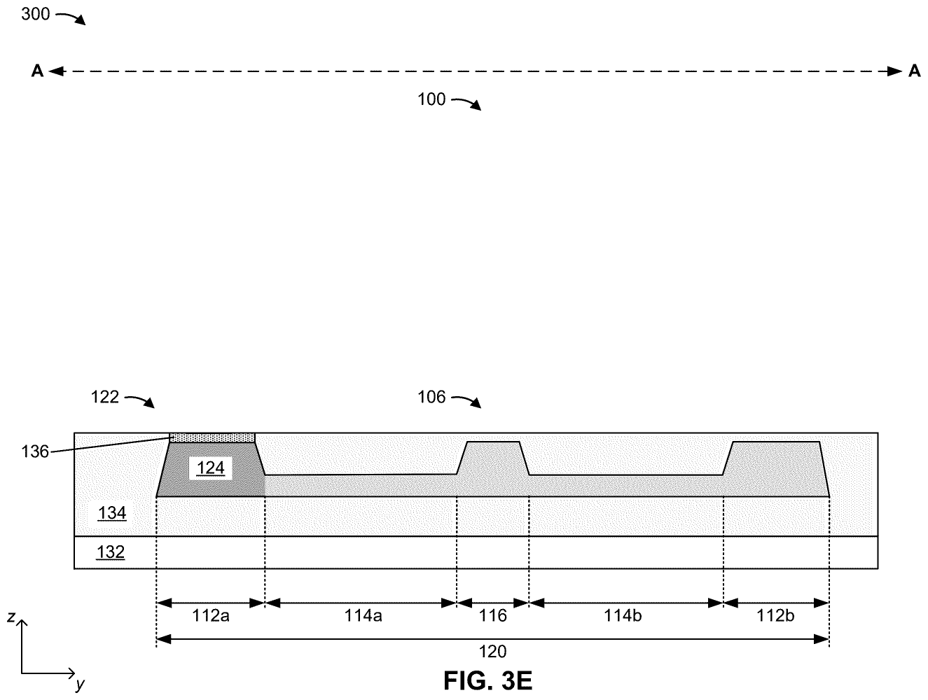

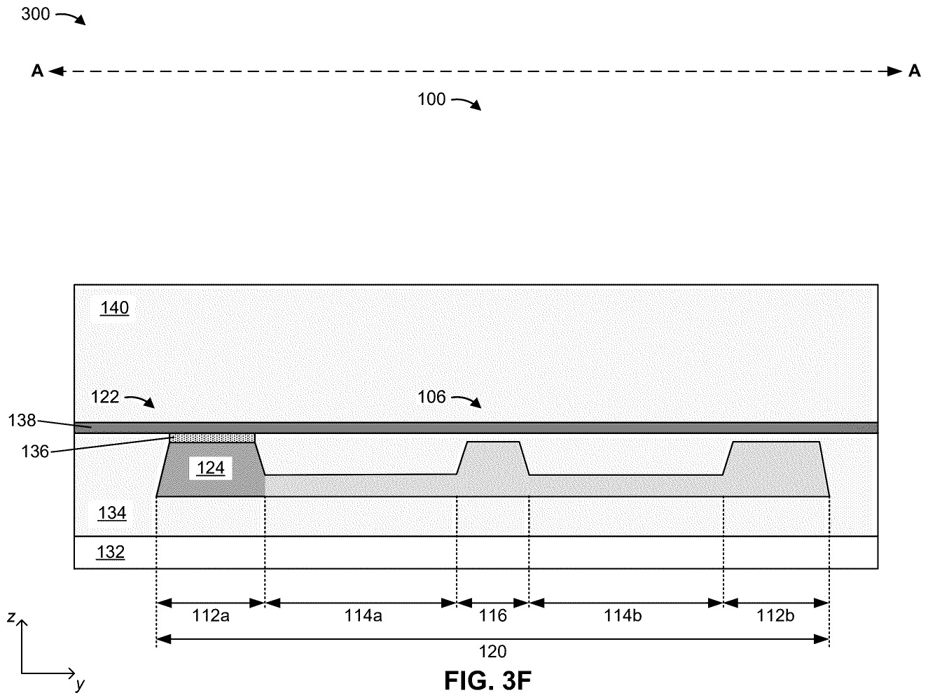

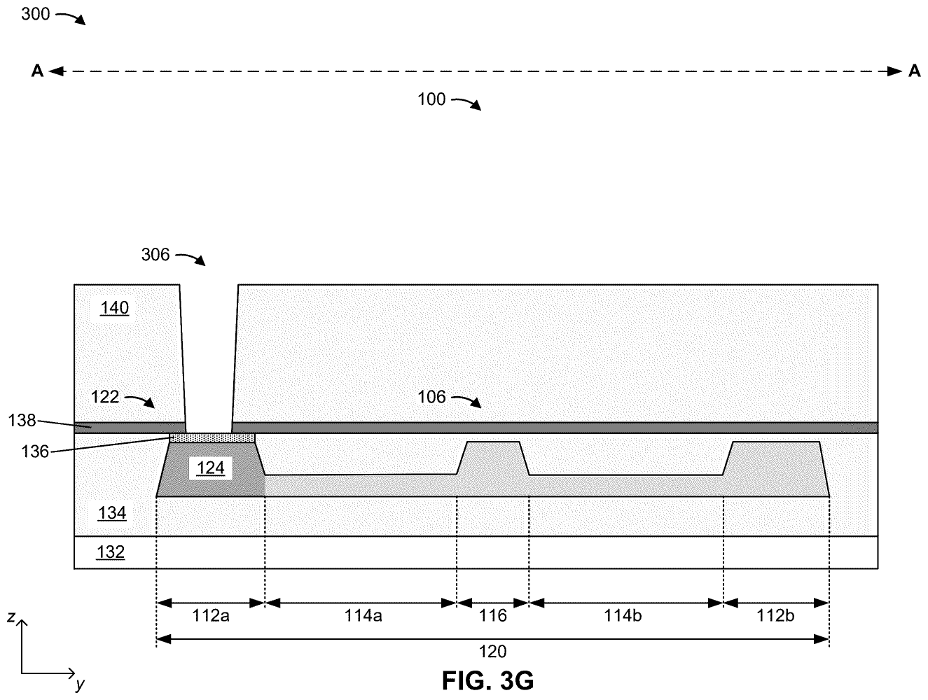

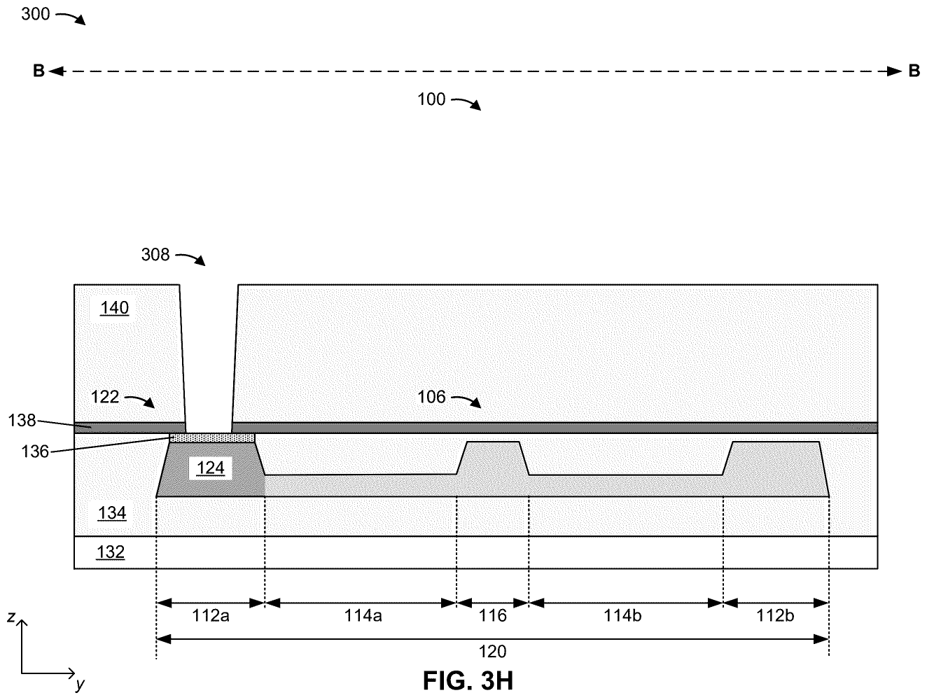

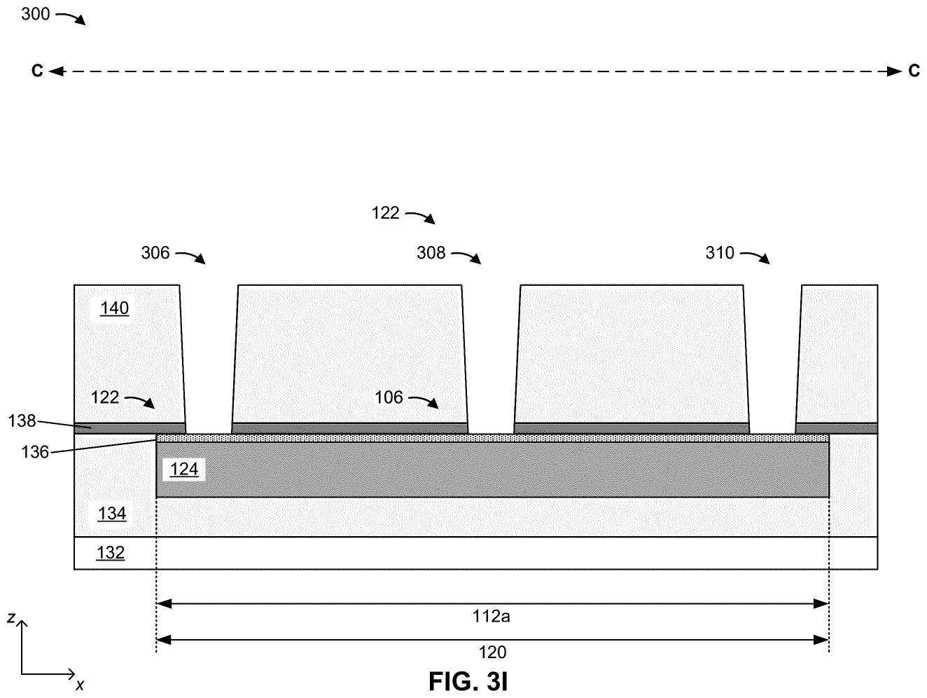

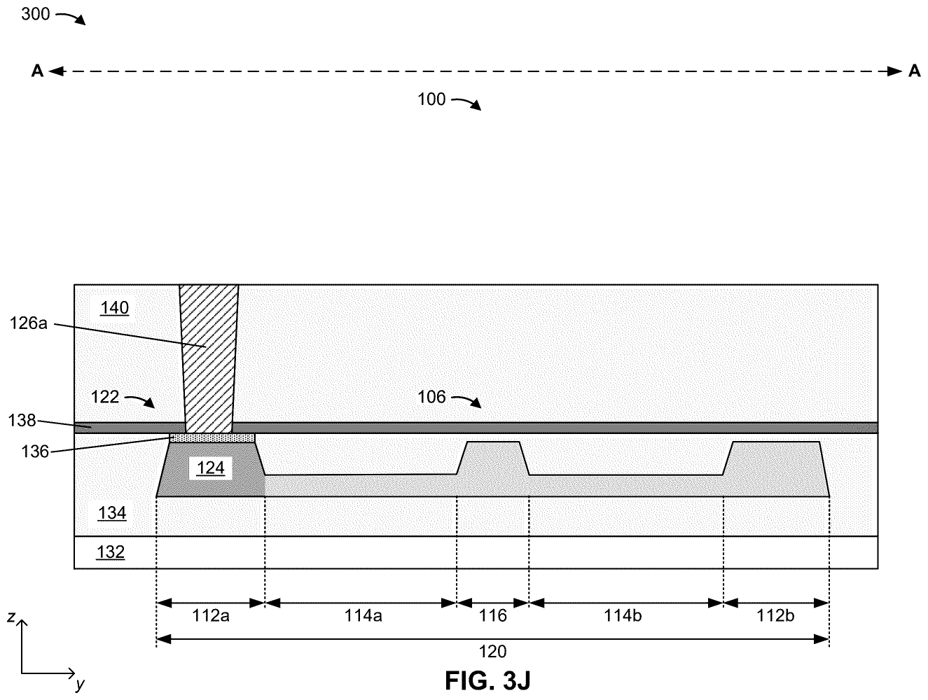

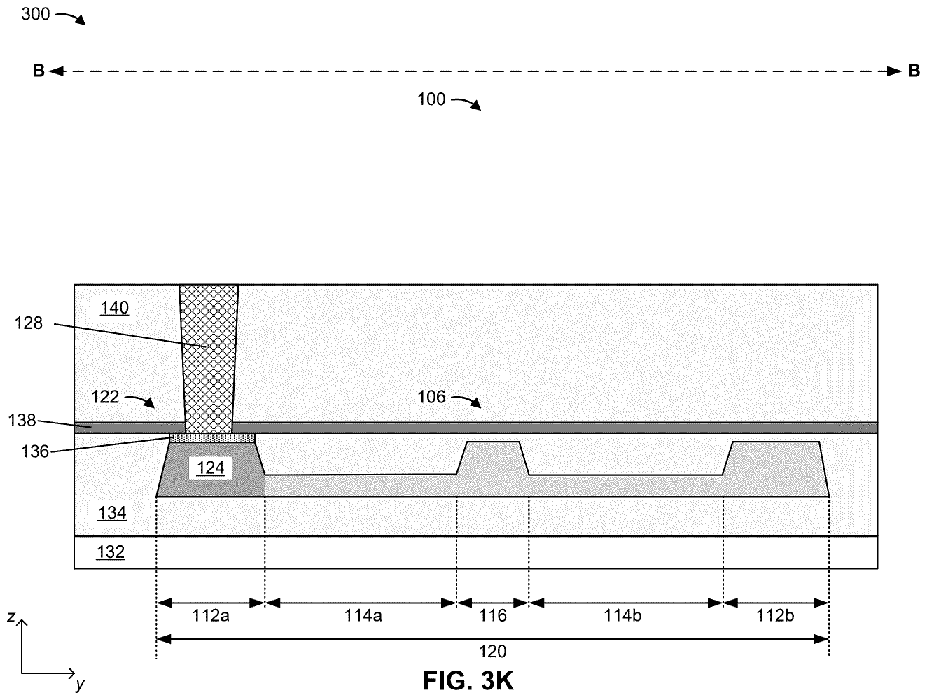

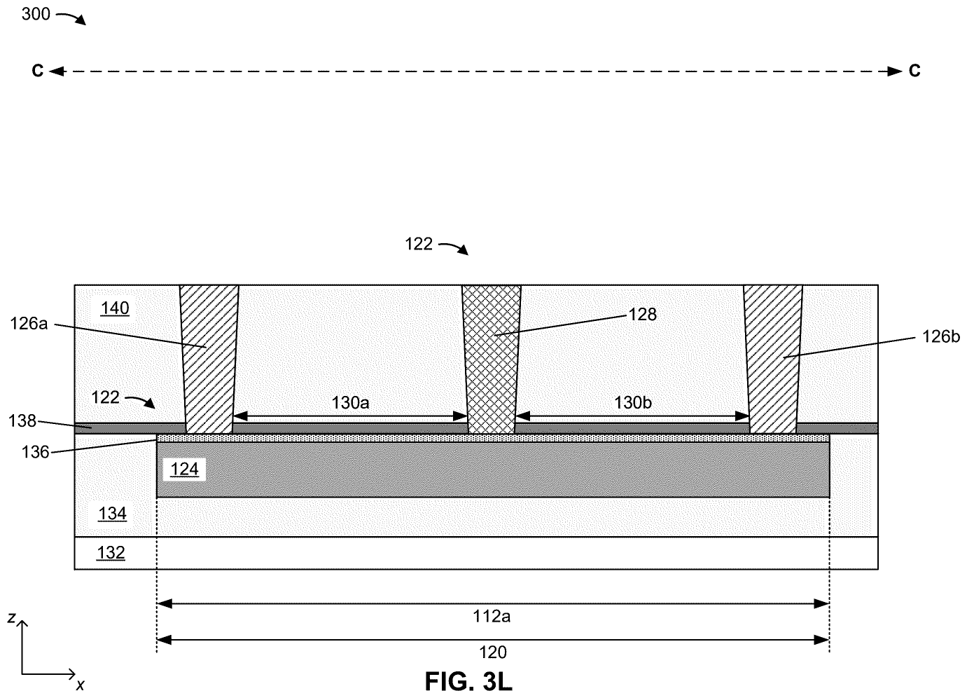

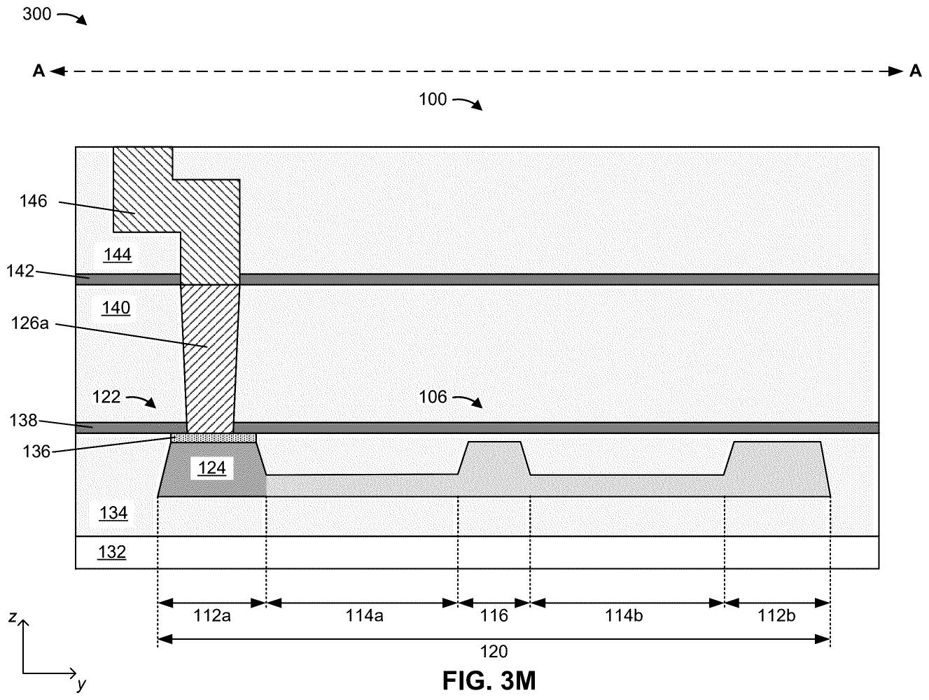

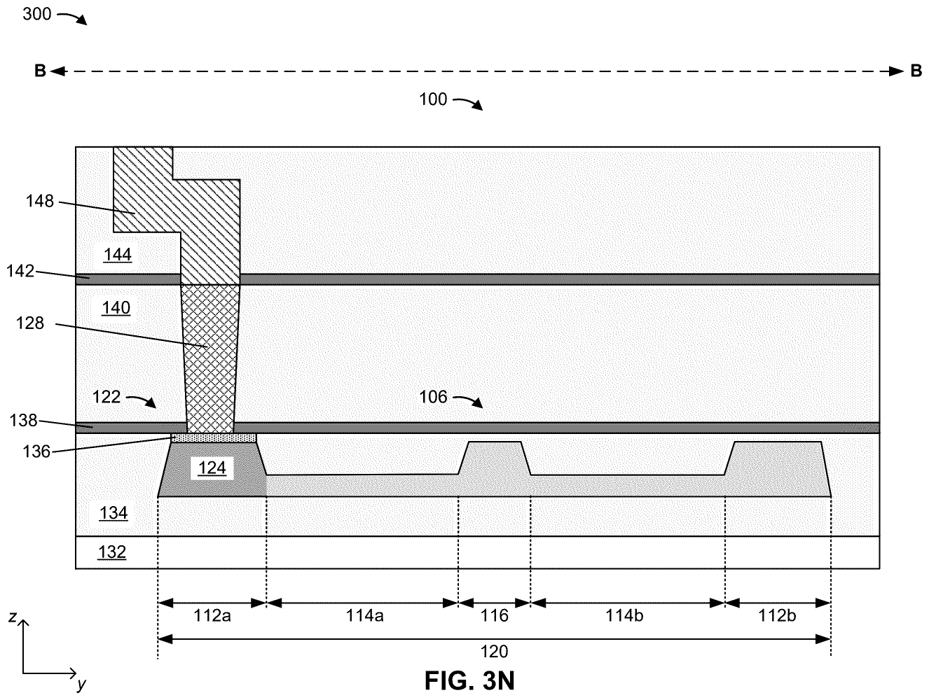

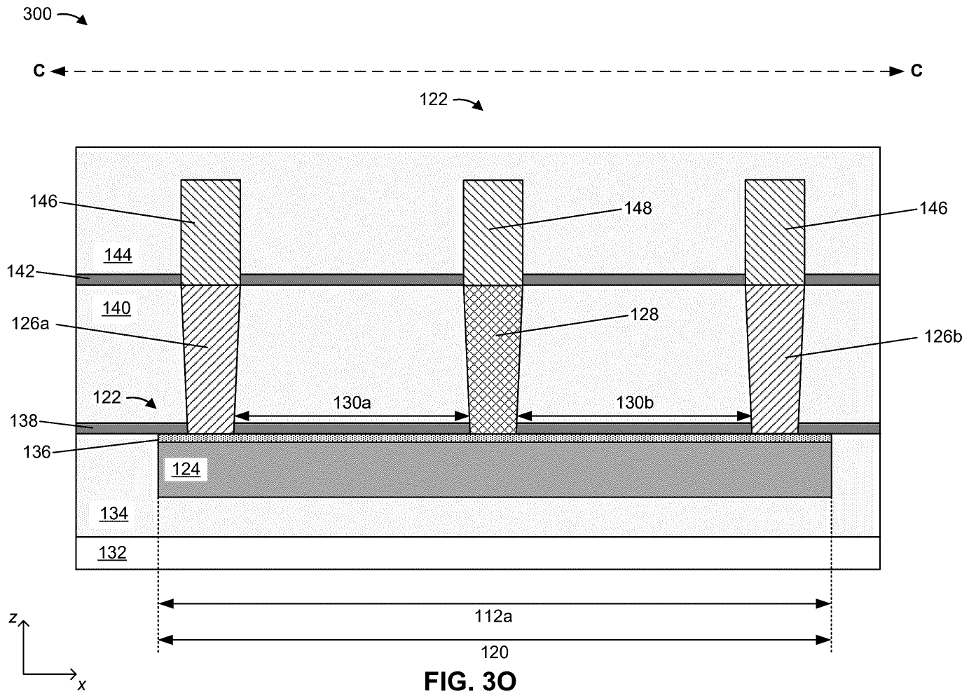

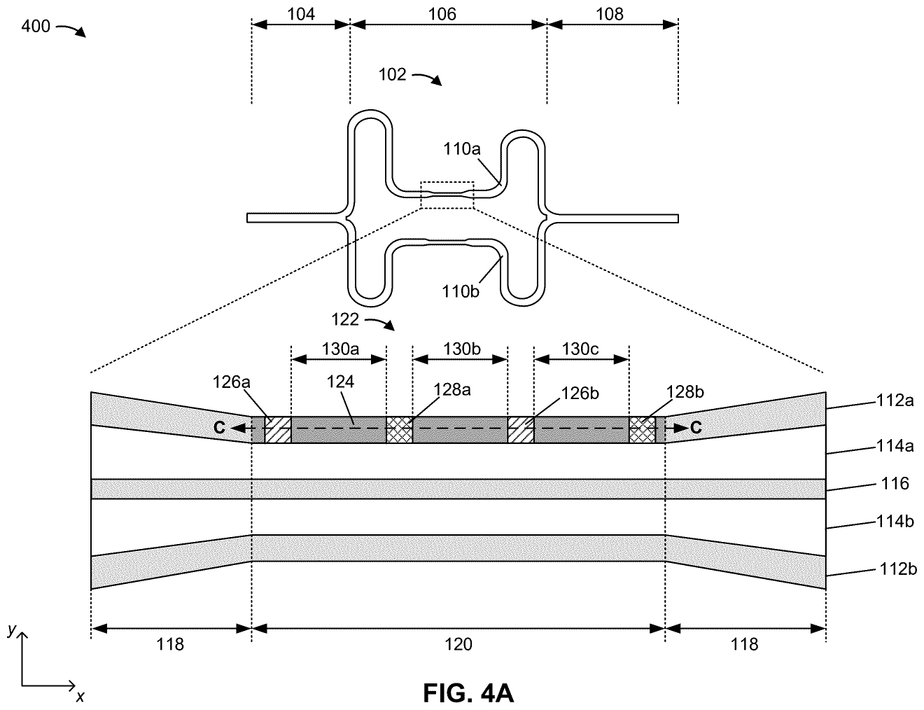

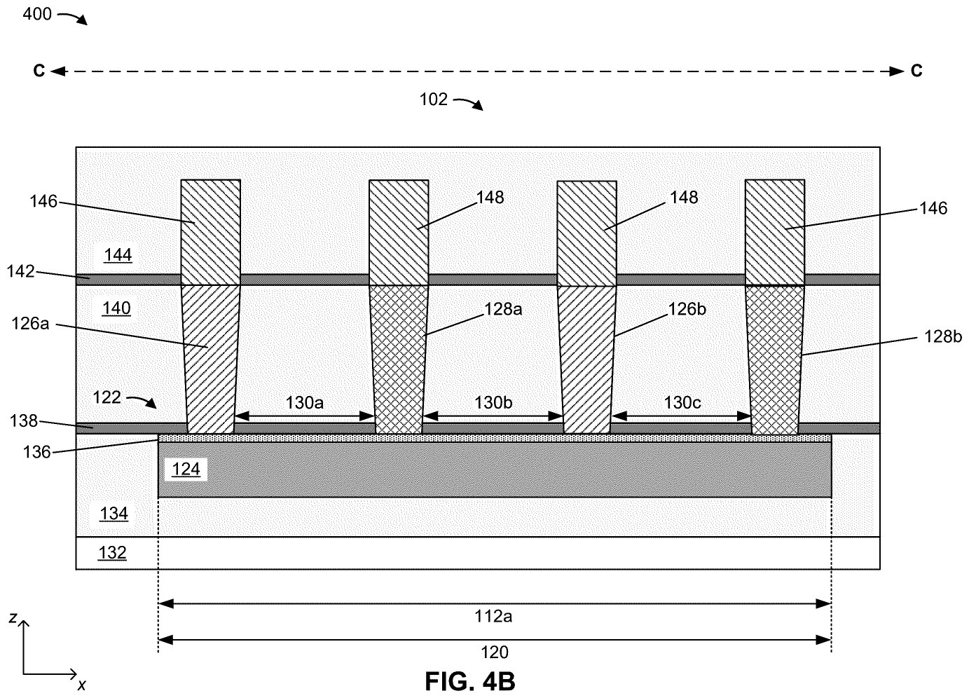

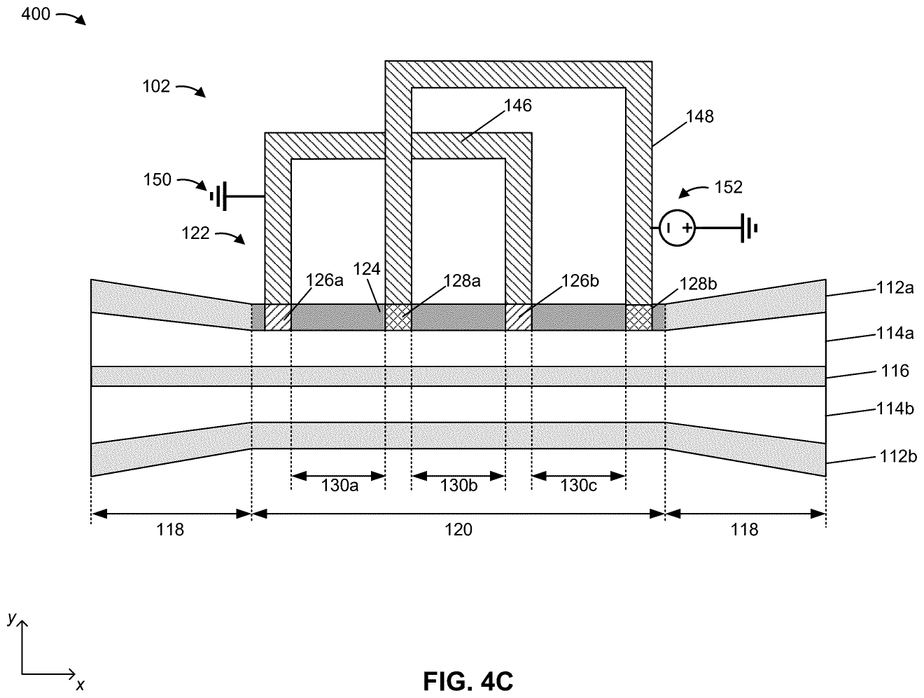

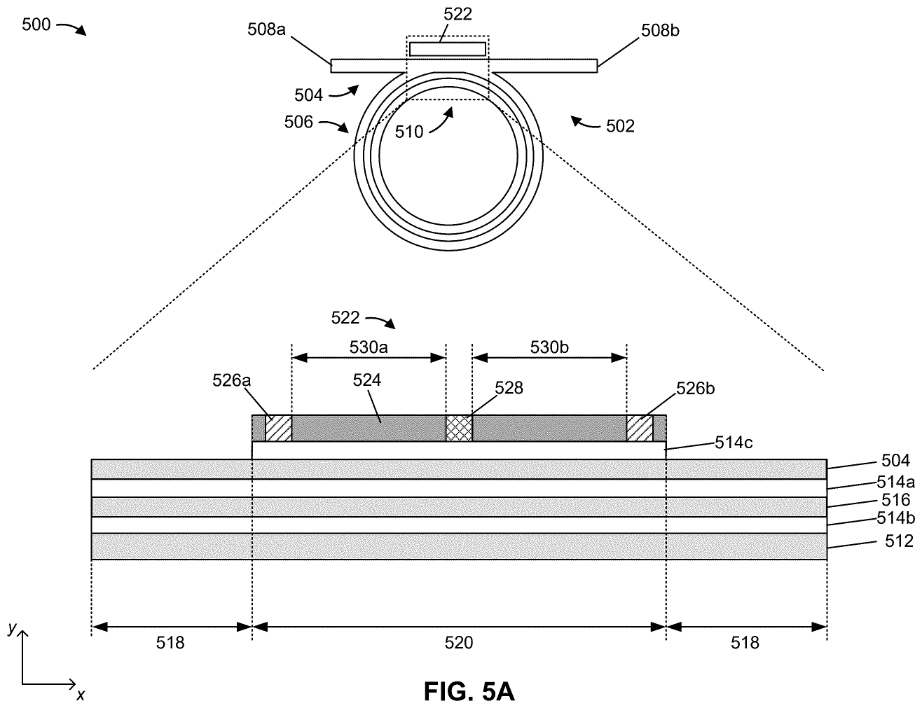

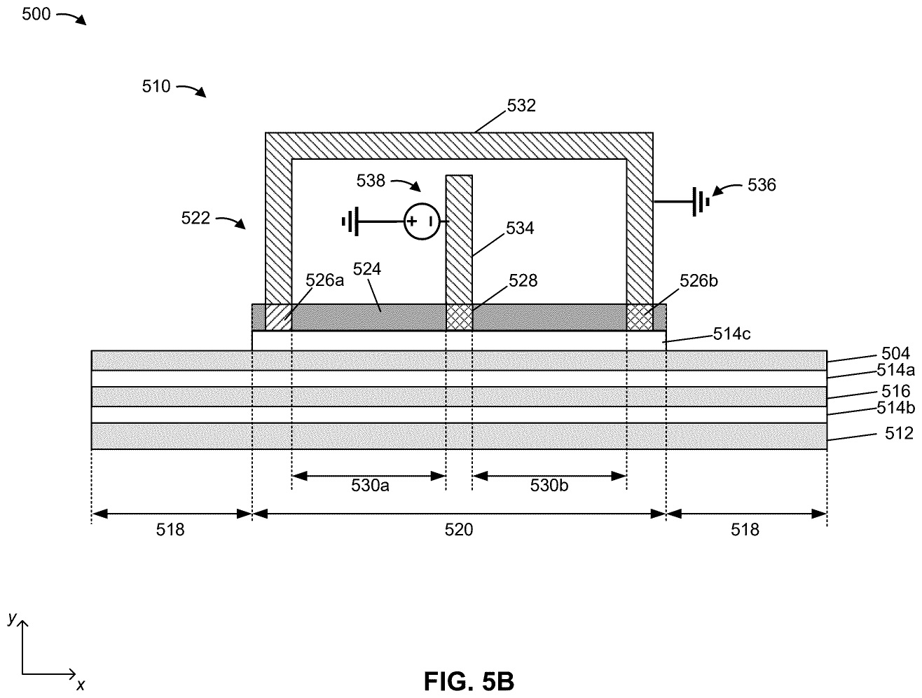

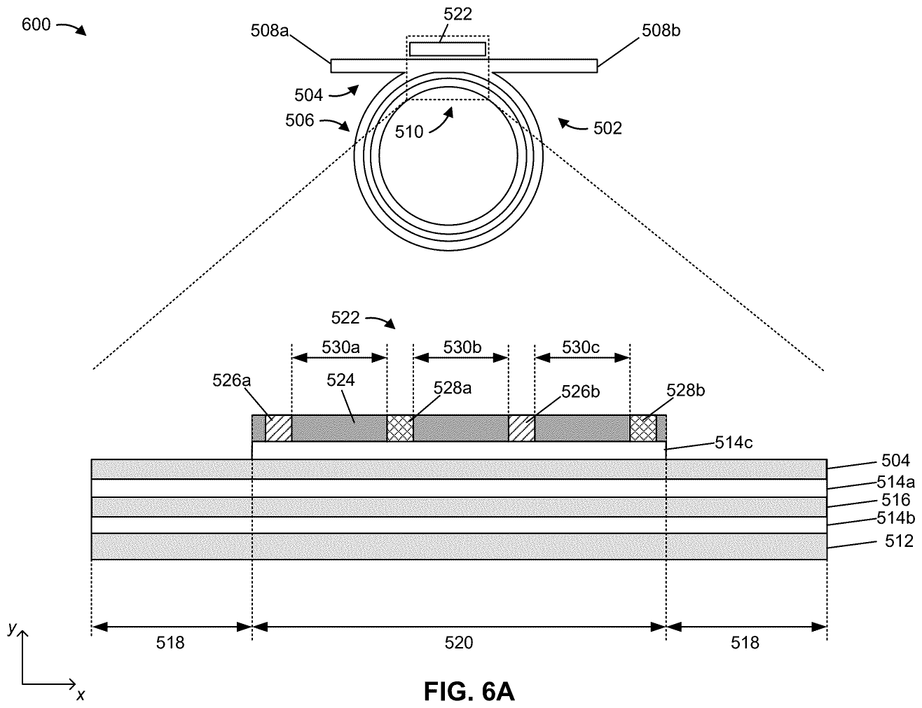

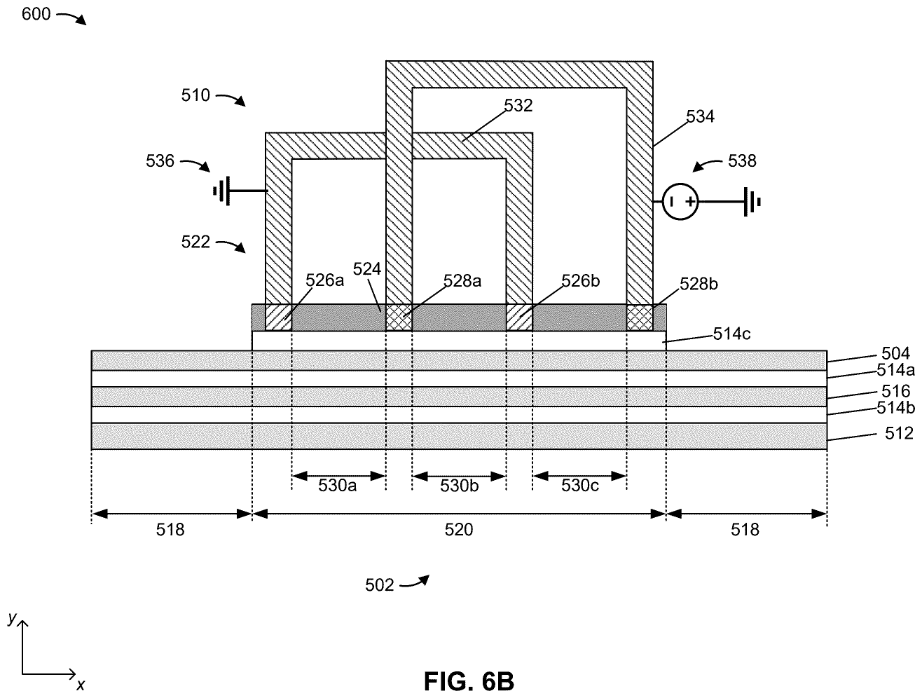

FIGS. 3A-30 are diagrams of an example implementation 300 of forming the semiconductor photonics device 100 (or a portion thereof) described herein. In particular, the example implementation 300 may include an example of forming an optical modulator structure 106 and an associated heater structure 122 of the semiconductor photonics device 100. In some implementations, one or more of the semiconductor processing operations described in connection with the example implementation 300 may be performed to form another semiconductor photonics device described herein, such as a semiconductor photonics device 400 illustrated and described in connection with FIGS. 4A-4C, a semiconductor photonics device 500 illustrated and described in connection with FIGS. 5A and 5B, a semiconductor photonics device 600 illustrated and described in connection with FIGS. 6A and 6B, and/or another semiconductor photonics device. In some implementations, one or more of the semiconductor processing operations described in connection with the example implementation 300 may be performed using one or more semiconductor processing tools, such as a deposition tool, an exposure tool, a developer tool, an etch tool, a planarization tool, an ion implantation tool, an annealing tool, and/or a wafer/die transport tool, among other examples.

As shown in FIG. 3A, a substrate 302 may be provided. The substrate 302 may include an SOI substrate that includes the semiconductor substrate 132 (e.g., a silicon (Si) substrate and/or another type of semiconductor substrate), the dielectric layer 134 (e.g., a BOX layer and/or another type of insulator layer) over and/or on the semiconductor substrate 132, and a semiconductor layer 304 (e.g., a silicon (Si) layer and/or another type of semiconductor layer) over and/or on the dielectric layer 134.

Alternatively, the semiconductor substrate 132 may be provided as a semiconductor wafer, and a deposition tool may be used to form the dielectric layer 134 over and/or on the semiconductor substrate 132, and may form or provide the semiconductor layer 304 over and/or on the dielectric layer 134. A deposition tool may be used to form the dielectric layer 134 using a chemical vapor deposition (CVD) technique, a physical vapor deposition (PVD) technique, an oxidation technique (e.g., a thermal oxidation technique), and/or another type of deposition technique. A deposition tool may be used to form the semiconductor layer 304 using an epitaxy technique and/or another type of deposition technique. Alternatively, the semiconductor layer 304 may be bonded to the dielectric layer 134 using a bonding tool. For example, the semiconductor layer 304 may be provided as another semiconductor wafer, a deposition tool may be used to form a bonding dielectric layer on the semiconductor wafer, and the bonding tool may be used to bond the bonding dielectric layer to the dielectric layer 134 to bond the semiconductor layer 304 to the dielectric layer 134.

As shown in FIG. 3B, portions of the semiconductor layer 304 are removed to form the optical modulator structure 106 and the semiconductor heater region 124 of the heater structure 122 in the semiconductor layer 304. In particular, the optical modulator structure 106 and the semiconductor heater region 124 are formed in the semiconductor layer 304 such that the optical modulator structure 106 and the semiconductor heater region 124 are physically connected in the semiconductor layer 304. The waveguide structure 116 of the optical modulator structure 106 and the semiconductor heater region 124 of the heater structure 122 are coupled through the connection section 114a of the optical modulator structure 106.

In some implementations, a pattern in a hard mask layer is used to etch the semiconductor layer 304 to form the optical modulator structure 106 and the semiconductor heater region 124. A deposition tool may be used to form the hard mask layer on the semiconductor layer 304 (e.g., using a CVD technique, a PVD technique, an atomic layer deposition (ALD) technique, an oxidation technique, and/or another type of deposition technique), and may form a photoresist layer on the hard mask layer (e.g., using a spin-coating technique and/or another type of deposition technique). An exposure tool may be used to expose the photoresist layer to a radiation source to form a pattern the photoresist layer. A developer tool may develop and remove portions of the photoresist layer to expose the pattern.

An etch tool may be used to etch the hard mask layer to transfer the pattern from the photoresist layer to the hard mask layer. An etch tool may be used to etch the semiconductor layer 304 based on the pattern in the hard mask layer to form the optical modulator structure 106 and the semiconductor heater region 124 by removing portions of the semiconductor layer 304 based on the pattern. In some implementations, the etch operation includes a plasma etch operation, a wet chemical etch operation, and/or another type of etch operation. In some implementations, a photoresist removal tool is used to remove the remaining portions of the photoresist layer (e.g., using a chemical stripper, plasma ashing, and/or another technique). In some implementations, a planarization tool is used to remove the remaining portions of the hard mask layer using a chemical mechanical planarization (CMP) technique and/or another type of planarization technique.

As shown in FIG. 3C, additional material of the dielectric layer 134 may be deposited around the optical modulator structure 106 and the semiconductor heater region 124. The additional material may correspond to the STI portion of the dielectric layer 134. A deposition tool may be used to deposit the additional material of the dielectric layer 134 using a CVD technique, a PVD technique, an oxidation technique (e.g., a thermal oxidation technique), and/or another type of deposition technique. In some implementations, an STI liner is first deposited onto the dielectric layer 134, and the additional material of the dielectric layer 134 is deposited onto the STI liner.

A planarization tool may be used to perform a CMP operation and/or another type of planarization operation to planarize the dielectric layer 134. This may result in the top surface of the dielectric layer 134 being approximately co-planar with top surfaces of the optical modulator structure 106 and the semiconductor heater region 124.

As shown in FIG. 3D, a portion of the pad section 112a in the modulation segment 120 of the optical modulator structure 106 may be doped with one or more types of dopants to dope the semiconductor heater region 124 of the heater structure 122. An ion implantation tool may be used to dope the portion of the pad section 112a by implanting ions into the semiconductor material of the pad section 112a. The dopants may include n-type dopants, p-type dopants, and/or another dopant type. The other portions of the optical modulator structure 106 may remain undoped or may be doped in addition to the semiconductor heater region 124. In some implementations, an implant mask may be formed and used to selectively dope the pad section 112a. Alternatively, the semiconductor layer 304 may be doped (e.g., using an implant mask) prior to being etched to form the pad section 112a.

As shown in FIG. 3E, additional material of the dielectric layer 134 may be deposited above the optical modulator structure 106 and the semiconductor heater region 124. A deposition tool may be used to deposit the additional material of the dielectric layer 134 using a CVD technique (e.g., a remote plasma oxide (RPO) CVD technique) and/or another type of deposition technique.

An opening may be formed through the dielectric layer 134 above the semiconductor heater region 124, and a silicide layer 136 may be formed on the semiconductor heater region 124. Forming the silicide layer 136 may include depositing (e.g., using a deposition tool) a metal layer on the semiconductor heater region 124, and using an annealing tool to perform an annealing operation on the metal layer. The annealing operation causes the metal layer to react with the semiconductor material of the semiconductor heater region 124, which results information of the silicide layer 136.

As shown in FIG. 3F, the ESL 138 may be formed above the optical modulator structure 106, above the semiconductor heater region 124, and above the dielectric layer 134. The ILD layer 140 may be formed above the ESL 138. A deposition tool may be used to deposit the ESL 138 and/or the ILD layer 140 using a PVD technique, an ALD technique, a CVD technique, an oxidation technique, and/or another suitable deposition technique. In some implementations, a planarization tool may be used to perform a planarization operation (e.g., a CMP operation) to planarize the ESL 138 and/or the ILD layer 140 after the ESL 138 and/or the ILD layer 140 are deposited.

As shown in FIGS. 3G-31, a plurality of recesses are formed through the ESL 138 and through the ILD layer 140 to the silicide layer 136 above the semiconductor heater region 124. The plurality of recesses may include a recess 306, a recess 308, and a recess 310, among other examples. Alternatively, the recesses 306, 308, and/or 310 may be formed prior to formation of the silicide layer 136, and the silicide layer 136 may be formed on the heater region 124 through the recesses 306, 308, and/or 310. The recess 306 may be formed at a first end of the semiconductor heater region 124. The recess 310 may be formed at a second end of the semiconductor heater region 124 opposing the first end in the x-direction. The recess 308 may be formed between the recess 306 and the recess 310 in the x-direction.

In some implementations, a pattern in a photoresist layer is used to etch the ESL 138 and/or the ILD layer 140 to form the recesses 306-310. In these implementations, a deposition tool may be used to form the photoresist layer on the ILD layer 140. An exposure tool may be used to expose the photoresist layer to a radiation source to pattern the photoresist layer. A developer tool may be used to develop and remove portions of the photoresist layer to expose the pattern. An etch tool may be used to etch the ESL 138 and/or the ILD layer 140 based on the pattern to form the recesses 306-310. In some implementations, the etch operation includes dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the ESL 138 and/or the ILD layer 140 based on a pattern.

As shown in FIGS. 3J-3L, the contact structures 126a, 126b, and 128 are formed such that the contact structures 126a, 126b, and 128 each land on the semiconductor heater region 124. In particular, the contact structures 126a, 126b, and 128 may land on the silicide layer 136 that is on the semiconductor heater region 124. The contact structure 126a may be formed in the recess 306 such that the contact structure 126a is located at the first side of the semiconductor heater region 124. The contact structure 126b may be formed in the recess 310 such that the contact structure 126b is located at the second side of the semiconductor heater region 124. The contact structure 128 may be formed in the recess 308 such that the contact structure 128 is formed between the contact structures 126a and 126b in the x-direction.

In some implementations, the contact structures 126a, 126b, and 128 are formed in the same deposition operation, or in the same sequence of operations. In some implementations, two or more of the contact structures 126a, 126b, and 128 are formed in different deposition operations. A deposition tool may be used to deposit the contact structures 126a, 126b, and/or 128 using a CVD technique, a PVD technique, an ALD technique, an electroplating technique, and/or another suitable deposition technique. The contact structures 126a, 126b, and/or 128 may be deposited in one or more deposition operations. In some implementations, a seed layer is first deposited, and the contact structures 126a, 126b, and/or 128 are deposited on the seed layer. In some implementations, a planarization tool is used to perform a planarization operation (e.g., a CMP operation) to planarize the contact structures 126a, 126b, and/or 128 after the contact structures 126a, 126b, and/or 128 are deposited.

As shown in FIGS. 3M-30, the ESL 142 and the ILD layer 144 are formed above the ILD layer 140. The ESL 142 may be formed above the ILD layer 144, and the ILD layer 144 may be formed above the ESL 142. A deposition tool may be used to deposit the ESL 142 and/or the ILD layer 144 using a PVD technique, an ALD technique, a CVD technique, an oxidation technique, and/or another suitable deposition technique. In some implementations, a planarization tool may be used to perform a planarization operation (e.g., a CMP operation) to planarize the ESL 142 and/or the ILD layer 144 after the ESL 142 and/or the ILD layer 144 are deposited.

As further shown in FIGS. 3M-30, the metallization layers 146 and 148 are formed in the ESL 142 and/or in the ILD layer 144. The metallization layer 146 may be formed such that the metallization layer 146 lands on the contact structures 126a and 126b. The metallization layer 148 may be formed such that the metallization layer 148 lands on the contact structure 128.

To form the metallization layers 146 and 148, recesses may be formed through the ESL 142 and the ILD layer 144. In some implementations, a pattern in a photoresist layer is used to etch the ESL 142 and/or the ILD layer 144 to form the recesses. A recess may be formed above the contact structures 126a and 126b such that the contact structures 126a and 126b are exposed through the recess. Another recess may be formed above the contact structure 128 such that the contact structure 128 is exposed through the recess.

In these implementations, a deposition tool may be used to form the photoresist layer on the ILD layer 144. An exposure tool may be used to expose the photoresist layer to a radiation source to pattern the photoresist layer. A developer tool may be used to develop and remove portions of the photoresist layer to expose the pattern. An etch tool may be used to etch the ESL 142 and/or the ILD layer 144 based on the pattern to form the recesses. In some implementations, the etch operation includes dry etch operation (e.g., a plasma-based etch operation, a gas-based etch operation), a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the ESL 142 and/or the ILD layer 144 based on a pattern.

A deposition tool may be used to deposit the metallization layers 146 and/or 148 using a CVD technique, a PVD technique, an ALD technique, an electroplating technique, and/or another suitable deposition technique. The metallization layers 146 and/or 148 may be deposited in one or more deposition operations. In some implementations, a seed layer is first deposited, and the metallization layers 146 and/or 148 are deposited on the seed layer. In some implementations, a planarization tool is used to perform a planarization operation (e.g., a CMP operation) to planarize the metallization layers 146 and/or 148 after the metallization layers 146 and/or 148 are deposited.

As indicated above, FIGS. 3A-30 are provided as an example. Other examples may differ from what is described with regard to FIGS. 3A-30.

FIGS. 4A-4C are diagrams of an example semiconductor photonics device 400 described herein. The semiconductor photonics device 400 may be formed using similar techniques and processes as described in connection with FIGS. 3A-30.

FIG. 4A illustrates a top view of the semiconductor photonics device 400. As shown in FIG. 4A, the semiconductor photonics device 400 includes a photonic integrated circuit 102 similar to the photonic integrated circuit 102 of the semiconductor photonics device 100 illustrated and described in connection with FIGS. 1A-1E. For example, the photonic integrated circuit 102 in the semiconductor photonics device 400 includes a waveguide structure 104 optically and/or physically coupled with an optical modulator structure 106, and another waveguide structure 108, where the waveguide structure 104 and the waveguide structure 108 are coupled with the optical modulator structure 106 at opposing ends of the optical modulator structure 106. Moreover, the optical modulator structure 106 in the photonic integrated circuit 102 of the semiconductor photonics device 400 includes a heater structure 122 that includes a semiconductor heater region 124 that is partitioned into a plurality of segments (e.g., a plurality semiconductor heater segments) by a plurality of contacts, similar to the heater structure 122 in the photonic integrated circuit 102 of the semiconductor photonics device 100.

However, and as shown in FIG. 4A, the heater structure 122 in the photonic integrated circuit 102 of the semiconductor photonics device 400 includes a plurality of contact structures 128a and 128b to further partition the semiconductor heater region 124 into an additional segment 130c. Thus, the semiconductor heater region 124 in the semiconductor photonics device 400 includes segments 130a-130c, where the segment 130a is located between (and defined by) the contact structures 126a and 128a, the segment 130b is located between (and defined by) the contact structures 126b and 128a, and the segment 130c is located between (and defined by) the contact structures 126b and 128b. This enables the phase shift voltage for achieving a particular power level for the heater structure 122 may be further reduced in that the phase shift voltage is applied in parallel across a greater quantity of segments of the semiconductor heater region 124.

As shown in FIG. 4A, the contact structure 126a is located at a first end of the semiconductor heater region 124, and the contact structure 128b is located at a second end of the semiconductor heater region 124 opposing the first end. The contact structure 126b is located between the contact structure 126a and the contact structure 128b, and is more particularly located between the contact structure 128a and the contact structure 128b. The contact structure 128a is located between the contact structure 126a and the contact structure 128b, and is more particularly located between the contact structure 126a and the contact structure 126b.

FIG. 4B illustrates a cross-section view along the line C-C in FIG. 4A. As shown in FIG. 4B, the contact structures 126a, 126b, 128a, and 128b may be located on the semiconductor heater region 124, and may be arranged in the x-direction along the semiconductor heater region 124. The contact structures 126a, 126b may be electrically coupled and/or physically coupled to the metallization layer 146, and the contact structures 128a, 128b may be electrically coupled and/or physically coupled to the metallization layer 148.

FIG. 4C illustrates a top view of a portion of the optical modulator structure 106 that includes the heater structure 122. FIG. 4C illustrates additional details of the metallization layers 146 and 148 in the semiconductor photonics device 400. As shown in FIG. 4C, the metallization layer 146 is electrically coupled and/or physically coupled to the contact structures 126a and 126b such that the contact structures 126a and 126b are electrically coupled in parallel, and such that the contact structures 126a and 126b are electrically coupled in parallel to the electrical ground 150.

The metallization layer 148 is electrically coupled and/or physically coupled to the contact structures 128a and 128b such that the contact structures 128a and 128b are electrically coupled in parallel, and such that the contact structures 128a and 128b are electrically coupled in parallel to the voltage source 152. The parallel connections of the contact structures 126a and 126b to the electrical ground 150, and the parallel connections of the contact structures 128a and 128b to the voltage source 152, enables a phase shift voltage to be applied to the segment 130a across the contact structure 126a and 128a, enables the phase shift voltage to be applied to the segment 130b across the contact structure 126b and 128a, and enables the phase shift voltage to be applied to the segment 130c across the contact structure 126b and 128b in parallel.

As indicated above, FIGS. 4A-4C are provided as an example. Other examples may differ from what is described with regard to FIGS. 4A-4C. For example, additional contact structures may be included on the semiconductor heater region 124 to further partition the semiconductor heater region 124 into additional segments. Quantities of segments, other than those illustrated and described herein, are within the scope of the present disclosure.

FIGS. 5A and 5B are diagrams of an example semiconductor photonics device 500 described herein. FIG. 5A illustrates a top view of the semiconductor photonics device 500.

The photonic integrated circuit 502 may include a bus optical waveguide structure 504 and an optical modulator structure 506. The bus optical waveguide structure 504 has an input end 508a and an output pend 508b. The optical modulator structure 506 and the bus optical waveguide structure 504 may be adjacent and/or side-by-side in a y-direction in the semiconductor photonics device 500 to enable coupling of optical signals between the optical modulator structure 506 and the bus optical waveguide structure 504 in a coupling region 510. Unmodulated input optical signals may be received in the bus optical waveguide structure 504 at the input end 508a, and output optical signals that are modulated in the optical modulator structure 506 may be provided from the bus optical waveguide structure 504 at the output end 508b.

The bus optical waveguide structure 504 may extend in an x-direction along a side of the optical modulator structure 506. The bus optical waveguide structure 504 enables confinement of the optical signal, which may reduce optical loss and increase propagation efficiency for the optical signal. The bus optical waveguide structure 504 may include an elongated waveguide that includes a slab waveguide, a rib waveguide, and/or another type of waveguide structure. Input optical signals may enter the bus optical waveguide structure 504 at a first end of the bus optical waveguide structure 504, and output optical signals (e.g., modulated optical signals) may be provided from the bus optical waveguide structure 504 at a second (opposing) end of the bus optical waveguide structure 504. Optical signals may couple between the bus optical waveguide structure 504 and the optical modulator structure 506 at a coupling region where the bus optical waveguide structure 504 and the optical modulator structure 506 are laterally adjacent.

The optical modulator structure 506 includes a micro-ring modulator (MRM) or another type of closed-loop modulator structure that includes a pad section 512, a plurality of connection sections 514a and 514b, and a closed-loop optical waveguide structure 516. The closed-loop optical waveguide structure 516 is a continuous waveguide structure that connects to itself with no end points. The structure of the optical modulator structure 506 differs from the optical modulator structure 106 in that the optical modulator structure 106 (e.g., an MZM) has end points coupled to the waveguide structures 104 and 108. Instead of optical signals being coupled to and from the optical modulator structure 106 through propagation of the optical signals through the waveguide structures 104 and 108, optical signals are coupled between the bus optical waveguide structure 504 and the closed-loop optical waveguide structure 516 of the optical modulator structure 506 through evanescent coupling in the coupling region 510. Evanescent coupling from the bus optical waveguide structure 504 and the closed-loop optical waveguide structure 516 occurs when the evanescent field of the optical signals propagating through the bus optical waveguide structure 504 extends into the portion of the closed-loop optical waveguide structure 516 that is adjacent to the bus optical waveguide structure 504 in the coupling region 510. Similarly, evanescent coupling from the closed-loop optical waveguide structure 516 to the bus optical waveguide structure 504 occurs when the evanescent field of the optical signals propagating through the closed-loop optical waveguide structure 516 extends into the portion of the bus optical waveguide structure 504 in the coupling region 510.

The bus optical waveguide structure 504, the pad section 512, the connection sections 514a and 514b, and the closed-loop optical waveguide structure 516 may be formed in a semiconductor layer and may include silicon (Si), silicon doped with one or more types of dopants, germanium (Ge), silicon germanium (SiGe), and/or another semiconductor material.

As further shown in FIG. 5A, the optical modulator structure 506 includes a resonator segment 518 and a modulation segment 520. The resonator segment 518 includes the main length of the optical modulator structure 506 around the closed-loop top view shape of the optical modulator structure 506. The modulation segment 520 may be included in the coupling region 510 and may include a heater structure 522 configured to modulate optical signals that then propagate around the optical modulator structure 506 in the resonator segment 518. The heater structure 522 may be included in a pad segment laterally adjacent to the bus optical waveguide structure 504, and may be configured to generate heat that is to be injected into the closed-loop optical waveguide structure 516 through the bus optical waveguide structure 504 and through the connection section 514a to modify the temperature of the closed-loop optical waveguide structure 516 in the modulation segment 520. Thus, the heater structure 522 may be referred to as a modulator heater structure. The change in temperature of the closed-loop optical waveguide structure 516 in the modulation segment 520 modifies the refractive index of the closed-loop optical waveguide structure 516, which enables optical signals propagating through the closed-loop optical waveguide structure 516 to be modulated by thermo-optic modulation. Thus, the heater structure 522 may be referred to as a TPS structure or a thermo-optic phase shifter heater.

The heater structure 522 includes a semiconductor heater region 524, which includes a doped semiconductor region of the pad segment laterally adjacent to the bus optical waveguide structure 504 in the y-direction. Thus, the heater structure 522 may be referred to as a semiconductor heater structure. The semiconductor heater region 524 of the heater structure 522 extends alongside the bus optical waveguide structure 504 in the modulation segment 520 and is thermally coupled to the closed-loop optical waveguide structure 516 through the bus optical waveguide structure 504 and the connection section 514a and a connection section 514c. Heat generated in the semiconductor heater region 524 may propagate to the closed-loop optical waveguide structure 516 through the bus optical waveguide structure 504 and through the connection sections 514a and 514c.

The semiconductor heater region 524 includes a semiconductor material (e.g., silicon (Si), silicon germanium (SiGe), germanium (Ge)) that is doped with one or more types of dopants. For example, the semiconductor heater region 524 may include silicon doped with one or more n-type dopants such as phosphorous (P) and/or arsenic (As), among other examples. As another example, the semiconductor heater region 124 may include silicon doped with one or more p-type dopants such as boron (B) and/or gallium (Ga), among other examples.

The heater structure 522 includes a plurality of contact structures that are electrically coupled to the semiconductor heater region 524. The plurality of contact structures include a plurality of contact structures 526a and 526b, and a contact structure 528. The contact structures 526a and 526b are located at opposing ends of the semiconductor heater region 524, and the contact structure 528 is located between the contact structures 526a and 526b. The contact structures 526a, 526b, and 528 are located on the semiconductor heater region 524 and are arranged in the x-direction along the semiconductor heater region 524.

The contact structures 526a and 526b may be electrically coupled in parallel to an electrical ground in the semiconductor photonics device 500, and the contact structure 528 may be electrically coupled to a voltage source in the semiconductor photonics device 500. This enables a phase shift voltage input to be split across segments 530a and 530b (e.g., semiconductor heater segments) of the semiconductor heater region 524 in parallel. For example, a phase shift voltage may be applied across the contact structure 526a and the contact structure 528 to apply the phase shift voltage to the segment 530a, and the phase shift voltage may be applied across the contact structure 526b and the contact structure 528 to apply the phase shift voltage to the segment 530b. This enables a lower phase shift voltage to be used for achieving sufficient power for generating heat in the segments 530a and 530b as opposed to applying a larger phase shift voltage across the entire length of the semiconductor heater region 524.

FIG. 5B illustrates a top view of the coupling region 510 that includes the bus optical waveguide structure 504, the optical modulator structure 506, and the heater structure 522. As shown in FIG. 5B metallization layers 532 and 534, similar to the metallization layers 146 and 148 respectively, are included in the semiconductor photonics device 500. The metallization layer 532 is electrically coupled and/or physically coupled to the contact structures 526a and 526b such that the contact structures 526a and 526b are electrically coupled in parallel, and such that the contact structures 526a and 526b are electrically coupled in parallel to an electrical ground 536.

The metallization layer 534 is electrically coupled and/or physically coupled to the contact structure 528 such that the contact structure 528 is electrically coupled to a voltage source 538. The parallel connections of the contact structures 526a and 526b to the electrical ground 536, and the connection of the contact structure 528 to the voltage source 538, enables a phase shift voltage to be applied to the segment 530a across the contact structure 526a and 528, and enables the phase shift voltage to be applied to the segment 530b across the contact structure 526b and 528, in parallel.

The semiconductor photonics device 500 may be formed using similar techniques and processes as described in connection with FIGS. 3A-30. For example, the semiconductor photonics device 500 may be formed on a substrate 302 (e.g., an SOI substrate) that includes a semiconductor substrate 132, a dielectric layer (e.g., a BOX layer) 134, and a semiconductor layer 304. The bus optical waveguide structure 504, the optical modulator structure 506, and the semiconductor heater region 524 may be formed in the semiconductor layer 304 in a similar manner as described in connection with FIG. 3B. Additional material of the dielectric layer 134 may be formed around the bus optical waveguide structure 504, the optical modulator structure 506, and the semiconductor heater region 524 in a similar manner as described in connection with FIG. 3C, and the semiconductor heater region 524 may be doped in a similar manner as described in connection with FIG. 3D. A silicide layer 136 may be formed on the semiconductor heater region 524 in a similar manner as described in connection with FIG. 3E. An ESL 138 and an ILD layer 140 may be formed in a similar manner as described in connection with FIG. 3F. The contact structures 526a, 526b, and 528 may be formed on the semiconductor heater region 524 of the heater structure 522 in a similar manner as described in connection with FIGS. 3G-3L. The metallization layers 532 and 534 may be formed in a similar manner as described in connection with FIGS. 3M-30.

As indicated above, FIGS. 5A and 5B are provided as an example. Other examples may differ from what is described with regard to FIGS. 5A and 5B.

FIGS. 6A and 6B are diagrams of an example semiconductor photonics device 600 described herein. The semiconductor photonics device 600 may be formed using similar techniques and processes as described in connection with FIGS. 3A-30.

FIG. 6A illustrates a top view of the semiconductor photonics device 600. As shown in FIG. 6A, the semiconductor photonics device 600 includes a photonic integrated circuit 502 similar to the photonic integrated circuit 502 of the semiconductor photonics device 500 illustrated and described in connection with FIGS. 5A and 5B. For example, the photonic integrated circuit 502 in the semiconductor photonics device 600 includes a bus optical waveguide structure 504 optically and/or physically coupled with an optical modulator structure 506, where the optical modulator structure 506 and the bus optical waveguide structure 504 are laterally adjacent to enable coupling of optical signals between the optical modulator structure 506 and the bus optical waveguide structure 504 in a coupling region 510. Moreover, a heater structure 522 is configured to modulate optical signals that then propagate around the optical modulator structure 506. The heater structure 522 is configured to generate heat that is to be injected into the closed-loop optical waveguide structure 516 of the optical modulator structure 506 through the bus optical waveguide structure 504 and through the connection section 514a to modify the temperature of the closed-loop optical waveguide structure 516 in the modulation segment 520.

However, and as shown in FIG. 6A, the heater structure 522 in the photonic integrated circuit 502 of the semiconductor photonics device 600 includes a plurality of contact structures 528a and 528b to further partition the semiconductor heater region 524 into an additional segment 530c. Thus, the semiconductor heater region 524 in the semiconductor photonics device 600 includes segments 530a-530c, where the segment 530a is located between (and defined by) the contact structures 526a and 528a, the segment 530b is located between (and defined by) the contact structures 526b and 528a, and the segment 530c is located between (and defined by) the contact structures 526b and 528b. This enables the phase shift voltage for achieving a particular power level for the heater structure 522 may be further reduced in that the phase shift voltage is applied in parallel across a greater quantity of segments of the semiconductor heater region 524.

As shown in FIG. 6A, the contact structure 526a is located at a first end of the semiconductor heater region 524, and the contact structure 528b is located at a second end of the semiconductor heater region 524 opposing the first end. The contact structure 526b is located between the contact structure 526a and the contact structure 528b, and is more particularly located between the contact structure 528a and the contact structure 528b. The contact structure 528a is located between the contact structure 526a and the contact structure 528b, and is more particularly located between the contact structure 526a and the contact structure 526b.

FIG. 6B illustrates another top view of the coupling region 510 of the photonic integrated circuit 502, including a portion of the bus optical waveguide structure 504, a portion of the optical modulator structure 506, and the heater structure 522. FIG. 6B illustrates additional details of the metallization layers 532 and 534 in the semiconductor photonics device 600. As shown in FIG. 6B, the metallization layer 532 is electrically coupled and/or physically coupled to the contact structures 526a and 526b such that the contact structures 526a and 526b are electrically coupled in parallel, and such that the contact structures 526a and 526b are electrically coupled in parallel to the electrical ground 536.

The metallization layer 534 is electrically coupled and/or physically coupled to the contact structures 528a and 528b such that the contact structures 528a and 528b are electrically coupled in parallel, and such that the contact structures 528a and 528b are electrically coupled in parallel to the voltage source 538. The parallel connections of the contact structures 526a and 526b to the electrical ground 536, and the parallel connections of the contact structures 528a and 528b to the voltage source 538, enables a phase shift voltage to be applied to the segment 530a across the contact structure 526a and 528a, enables the phase shift voltage to be applied to the segment 530b across the contact structure 526b and 528a, and enables the phase shift voltage to be applied to the segment 530c across the contact structure 526b and 528b in parallel.

As indicated above, FIGS. 6A and 6B are provided as an example. Other examples may differ from what is described with regard to FIGS. 6A and 6B. For example, additional contact structures may be included on the semiconductor heater region 524 to further partition the semiconductor heater region 524 into additional segments. Quantities of segments, other than those illustrated and described herein, are within the scope of the present disclosure.

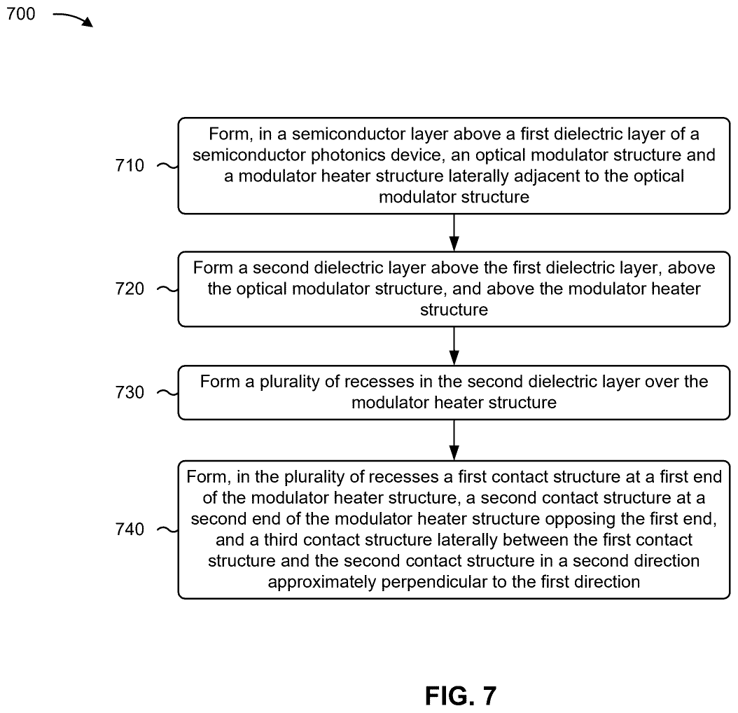

FIG. 7 is a flowchart of an example process 700 associated with forming a semiconductor photonics device described herein. In some implementations, one or more process blocks of FIG. 7 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 7, process 700 may include forming, in a semiconductor layer above a first dielectric layer of a semiconductor photonics device, an optical modulator structure and a modulator heater structure laterally adjacent to the optical modulator structure (block 710). For example, one or more semiconductor processing tools may be used to form, in a semiconductor layer (e.g., semiconductor layer 304) above a first dielectric layer (e.g., a dielectric layer 134) of a semiconductor photonics device (e.g., a semiconductor photonics device 100, a semiconductor photonics device 400, a semiconductor photonics device 500, a semiconductor photonics device 600), an optical modulator structure (e.g., an optical modulator structure 106, an optical modulator structure 506) and a modulator heater structure (e.g., a heater structure 122, a heater structure 522) laterally adjacent to the optical modulator structure, as described herein. In some implementations, the optical modulator structure and the modulator heater structure are physically coupled in the semiconductor layer and are arranged in a first direction (e.g., a y-direction) in the semiconductor photonics device.

As further shown in FIG. 7, process 700 may include forming a second dielectric layer above the first dielectric layer, above the optical modulator structure, and above the modulator heater structure (block 720). For example, one or more semiconductor processing tools may be used to form a second dielectric layer (e.g., e.g., an ESL 138, ILD layer 140) above the first dielectric layer, above the optical modulator structure, and above the modulator heater structure, as described herein.

As further shown in FIG. 7, process 700 may include forming a plurality of recesses in the second dielectric layer over the modulator heater structure (block 730). For example, one or more semiconductor processing tools may be used to form a plurality of recesses (e.g., a recess 306, a recess 308, a recess 310) in the second dielectric layer over the modulator heater structure, as described herein.

As further shown in FIG. 7, process 700 may include forming, in the plurality of recesses, a first contact structure at a first end of the modulator heater structure, a second contact structure at a second end of the modulator heater structure opposing the first end, and a third contact structure laterally between the first contact structure and the second contact structure in a second direction approximately perpendicular to the first direction (block 740). For example, one or more semiconductor processing tools may be used to form, in the plurality of recesses, a first contact structure (e.g., a contact structure 126a and/or 526a) at a first end of the modulator heater structure, a second contact structure (e.g., a contact structure 126b, 128b, 526b, and/or 528b) at a second end of the modulator heater structure opposing the first end, and a third contact structure (e.g., a contact structure 128, 128a, 526b, 528, and/or 528a) laterally between the first contact structure and the second contact structure in a second direction (e.g., an x-direction) approximately perpendicular to the first direction as described herein.

Process 700 may include additional implementations, such as any single implementation or any combination of implementations described below and/or in connection with one or more other processes described elsewhere herein.

In a first implementation, process 700 includes forming a third dielectric layer (e.g., an ESL 142, an ILD layer 144) above the second dielectric layer, above the first contact structure, above the second contact structure, and above the third contact structure, forming, in the third dielectric layer, a first metallization layer (e.g., a metallization layer 146, a metallization layer 532) that couples to the first contact structure and the second contact structure, wherein the first metallization layer couples the first contact structure and the second contact structure together, and forming, in the third dielectric layer, a second metallization layer (e.g., a metallization layer 148, a metallization layer 534) that couples to the third contact structure.

In a second implementation, process 700 includes doping the modulator heater structure with one or more types of dopants prior to forming the second dielectric layer.

In a third implementation, process 700 includes forming, in the plurality of recesses, a fourth contact structure (e.g., a contact structure 126b, 128, 128a, 526b, 528, and/or 528a) laterally between the first contact structure and the second contact structure in the second direction.

In a fourth implementation, process 700 includes forming a third dielectric layer (e.g., an ESL 142, an ILD layer 144) above the second dielectric layer, above the first contact structure, above the second contact structure, and above the third contact structure, forming, in the third dielectric layer, a first metallization layer (e.g., a metallization layer 146, a metallization layer 532) that couples to the first contact structure and the third contact structure, wherein the first metallization layer couples the first contact structure and the third contact structure together, and forming, in the third dielectric layer, a second metallization layer (e.g., a metallization layer 148, a metallization layer 534) that couples to the second contact structure and the fourth contact structure, wherein the second metallization layer couples the second contact structure and the fourth contact structure together.

In a fifth implementation, forming the first contact structure and the third contact structure comprises forming the first contact structure and the third contact structure such that the first contact structure and the third contact structure are spaced apart by a distance that is included in a range of approximately 5 microns to approximately 25 microns.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

In this way, a semiconductor photonics device includes an optical modulator structure that is thermally coupled to a heater structure for heating a waveguide structure of the optical modulator structure to modulate input optical signals by thermo-optic modulation. The heater structure includes a semiconductor heater element that is electrically coupled to a first electrode (e.g., a V_{π} electrode) by one or more first contacts, and is electrically coupled to a second electrode (e.g., a ground electrode) by a plurality second contacts. The one or more first contacts and the plurality of second contacts enable an electrical input to be applied across a plurality of parallel contact points to the semiconductor heater element, thereby enabling lower phase shift voltage to be used for achieving sufficient power for heating the waveguide structure of the optical modulator structure.

As described in greater detail above, some implementations described herein provide a semiconductor photonics device. The semiconductor photonics device includes a semiconductor waveguide. The semiconductor photonics device includes a semiconductor heater structure alongside and coupled to the semiconductor waveguide through a semiconductor connection section. The semiconductor heater structure includes a doped semiconductor region, a first contact structure at a first end of the doped semiconductor region, a second contact structure at a second end of the doped semiconductor region opposing the first end, and a third contact structure on the doped semiconductor region. The third contact structure is located between the first contact structure and the second contact structure.

As described in greater detail above, some implementations described herein provide a method. The method includes forming, in a semiconductor layer above a first dielectric layer of a semiconductor photonics device, an optical modulator structure and a modulator heater structure laterally adjacent to the optical modulator structure. The optical modulator structure and the modulator heater structure are physically coupled in the semiconductor layer and are arranged in a first direction in the semiconductor photonics device. The method includes forming a second dielectric layer above the first dielectric layer, above the optical modulator structure, and above the modulator heater structure. The method includes forming a plurality of recesses in the second dielectric layer over the modulator heater structure. The method includes forming, in the plurality of recesses, a first contact structure at a first end of the modulator heater structure, a second contact structure at a second end of the modulator heater structure opposing the first end, and a third contact structure laterally between the first contact structure and the second contact structure in a second direction approximately perpendicular to the first direction.

As described in greater detail above, some implementations described herein provide a semiconductor photonics device. The semiconductor photonics device includes an optical modulator structure in a semiconductor layer. The semiconductor photonics device includes a modulator heater structure coupled to the optical modulator structure through one or more semiconductor connection sections in the semiconductor layer. The modulator heater structure includes a first contact structure, a second contact structure, a third contact structure between the first contact structure and the second contact structure, a first semiconductor heater segment between the first contact structure and the third contact structure, and a second semiconductor heater segment between the second contact structure and the third contact structure.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a semiconductor waveguide; and
a semiconductor heater structure, alongside and coupled to the semiconductor waveguide through a semiconductor connection section, comprising:
a doped semiconductor region;
a first contact structure at a first end of the doped semiconductor region;
a second contact structure at a second end of the doped semiconductor region opposing the first end; and
a third contact structure on the doped semiconductor region,
wherein the third contact structure is located between the first contact structure and the second contact structure.

2. The semiconductor photonics device of claim 1, further comprising:
a first metallization layer electrically coupled to the first contact structure and to the second contact structure; and
a second metallization layer electrically coupled to the third contact structure.

3. The semiconductor photonics device of claim 2, wherein the second metallization layer is electrically coupled to a voltage source; and
wherein the first metallization layer is electrically coupled to an electrical ground.

4. The semiconductor photonics device of claim 1, further comprising:
a first metallization layer electrically coupled to the first contact structure; and
a second metallization layer electrically coupled to the second contact structure and to the third contact structure,
wherein the second metallization layer electrically couples the second contact structure and the third contact structure to a voltage source in parallel.

5. The semiconductor photonics device of claim 1, wherein the semiconductor heater structure further comprises:
a fourth contact structure on the doped semiconductor region,
wherein the fourth contact structure is located between the second contact structure and the third contact structure.

6. The semiconductor photonics device of claim 5, further comprising:
a first metallization layer electrically coupled to the first contact structure and to the third contact structure; and
a second metallization layer electrically coupled to the second contact structure and to the fourth contact structure.

7. The semiconductor photonics device of claim 6, wherein the second contact structure and the fourth contact structure are electrically coupled in parallel to a voltage source through the second metallization layer; and
wherein the first contact structure and the third contact structure are electrically coupled in parallel to an electrical ground through the first metallization layer.

8. A method, comprising:
forming, in a semiconductor layer above a first dielectric layer of a semiconductor photonics device:
an optical modulator structure; and
a modulator heater structure laterally adjacent to the optical modulator structure,
wherein the optical modulator structure and the modulator heater structure are physically coupled in the semiconductor layer and are arranged in a first direction in the semiconductor photonics device;
forming a second dielectric layer above the first dielectric layer, above the optical modulator structure, and above the modulator heater structure;
forming a plurality of recesses in the second dielectric layer over the modulator heater structure; and
forming, in the plurality of recesses:
a first contact structure at a first end of the modulator heater structure,
a second contact structure at a second end of the modulator heater structure opposing the first end, and
a third contact structure laterally between the first contact structure and the second contact structure in a second direction approximately perpendicular to the first direction.

9. The method of claim 8, further comprising:
forming a third dielectric layer above the second dielectric layer, above the first contact structure, above the second contact structure, and above the third contact structure;
forming, in the third dielectric layer, a first metallization layer that couples to the first contact structure and the second contact structure,
wherein the first metallization layer couples the first contact structure and the second contact structure together; and
forming, in the third dielectric layer, a second metallization layer that couples to the third contact structure.

10. The method of claim 8, further comprising doping the modulator heater structure with one or more types of dopants prior to forming the second dielectric layer.

11. The method of claim 8, further comprising:
forming, in the plurality of recesses, a fourth contact structure laterally between the first contact structure and the second contact structure in the second direction.

12. The method of claim 11, further comprising:
forming a third dielectric layer above the second dielectric layer, above the first contact structure, above the second contact structure, and above the third contact structure;
forming, in the third dielectric layer, a first metallization layer that couples to the first contact structure and the third contact structure,
wherein the first metallization layer couples the first contact structure and the third contact structure together; and
forming, in the third dielectric layer, a second metallization layer that couples to the second contact structure and the fourth contact structure,
wherein the second metallization layer couples the second contact structure and the fourth contact structure together.

13. The method of claim 8, wherein forming the first contact structure and the third contact structure comprises:
forming the first contact structure and the third contact structure such that the first contact structure and the third contact structure are spaced apart by a distance that is included in a range of approximately 5 microns to approximately 25 microns.

14. A semiconductor photonics device, comprising:
an optical modulator structure in a semiconductor layer; and
a modulator heater structure, coupled to the optical modulator structure through one or more semiconductor connection sections in the semiconductor layer, comprising:
a first contact structure;
a second contact structure;
a third contact structure between the first contact structure and the second contact structure;
a first semiconductor heater segment between the first contact structure and the third contact structure; and
a second semiconductor heater segment between the second contact structure and the third contact structure.

15. The semiconductor photonics device of claim 14, wherein the optical modulator structure comprises a Mach-Zender modulator (MZM);
wherein the first semiconductor heater segment and the second semiconductor heater segment are located in a pad section of the MZM; and
wherein the pad section is coupled to a waveguide section of the MZM through the one or more semiconductor connection sections.

16. The semiconductor photonics device of claim 14, wherein the optical modulator structure comprises a micro-ring modulator (MRM);
wherein a bus optical waveguide, in the semiconductor layer, is located between the MRM and the modulator heater structure; and
wherein the first semiconductor heater segment and the second semiconductor heater segment are coupled to a waveguide structure of the MRM through the bus optical waveguide and a plurality of semiconductor connection sections.

17. The semiconductor photonics device of claim 14, wherein the modulator heater structure further comprises:
a fourth contact structure,
wherein the fourth contact structure is located between the second contact structure and the third contact structure.

18. The semiconductor photonics device of claim 17, wherein the modulator heater structure further comprises:
a third semiconductor heater segment between the third contact structure and the fourth contact structure.

19. The semiconductor photonics device of claim 17, wherein the second contact structure and the fourth contact structure are electrically coupled in parallel to a voltage source; and
wherein the first contact structure and the third contact structure are electrically coupled in parallel to an electrical ground.

20. The semiconductor photonics device of claim 17, wherein the second contact structure and the fourth contact structure are electrically coupled in parallel to a first metallization layer in the semiconductor photonics device; and
wherein the first contact structure and the third contact structure are electrically coupled in parallel to a second metallization layer in the semiconductor photonics device.
